(19) United States
(12) Patent Application Publication
(10) Pub. No.: US 2011/0217512 A1
(43) Pub. Date: Sep. 8, 2011

(54) LAMINATED BODY AND METHOD FOR PRODUCING LAMINATED BODY

(75) Inventors: Masaru Heishi, Adachi-ku (JP); Nobuhiro Goto, Tsukuba-shi (JP); Hiroshi Kouyanagi, Tsukuba city (JP); Reona Yokota, Tsukuba city (JP); Toshiaki Tanaka, Tsukuba city (JP)

(73) Assignee: SEKISUI CHEMICAL CO., LTD., Osaka (JP)

(21) Appl. No.: 13/060,327

(22) PCT Filed: Aug. 28, 2009
(86) PCT No.: PCT/JP2009/065081

§ 371 Date: May 19, 2011

(30) Foreign Application Priority Data
Sep. 1, 2008 (JP) 2008-223494

(51) Int. Cl. B32B 27/38; B32B 33/00; B32B 37/02; B32B 37/06; B32B 37/10; B32B 37/12; B32B 37/14

(52) U.S. Cl. 428/141; 156/307.1; 156/83

(57) ABSTRACT

Provided is a laminated body capable of reducing the surface roughness of the surface of a roughening-treated cured body layer, and increasing the adhesive strength between the cured body layer and a metal layer. A laminated body includes a cured body layer formed by: laminating a resin film on a substrate, forming a preliminary-cured body layer by preliminary-curing the resin film at 100° C. to 200° C., and performing a roughening treatment on the surface of the cured object layer at 55° C. to 80° C. The resin film is formed from a resin composition including an epoxy resin, a phenol curing agent, a curing accelerator, and a surface-treated substance which is a surface treated, using 0.5 to 3.5 parts by weight of a silane coupling agent, on 100 parts by weight of inorganic filler with a mean particle diameter of 0.05 to 1.5 μm. The silane coupling agent has an epoxy group, an imidazole group, or an amino group.

### TECHNICAL FIELD

The present invention relates to a laminated body including a cured body layer having insulation characteristics formed on a substrate which is, for example, a monolayer or a multilayer printed wiring board and the like, and in more detail, a laminated body including a cured body layer having, for example, a metal layer formed on a surface thereof; and a method for producing the laminated body.

### BACKGROUND ART

A multilayer printed wiring board includes a plurality of insulation layers forming a lamination, and patterned metal wirings interposed between the insulation layers. Conventionally, various thermosetting resin compositions are used to form the insulation layers.

For example, the following patent literature 1 discloses a thermosetting resin composition including a thermosetting resin, a curing agent, and a filler whose surface is treated with an imidazole silane. There are imidazole groups existing on the surface of the above described filler. The imidazole groups act as curing catalysts and as reaction starting points. Therefore, strength of a cured object of the above described thermosetting resin composition can be increased. Additionally, patent literature 1 discloses that the thermosetting resin composition is useful for applications needing adherence, such as adhesives, sealing agents, coating materials, lamination materials, and forming materials.

The following patent literature 2 discloses an epoxy resin composition including an epoxy resin, a phenol resin, a curing agent, an inorganic filler, and an imidazole silane in which a Si atom and a N atom are not directly coupled. It is disclosed here that adhesiveness of a cured object of the epoxy resin composition to a semiconductor chip is high, and that it is difficult to separate the cured object from a semiconductor chip and the like even after IR reflow, since moisture resistance of the cured object is high.

Furthermore, the following patent literature 3 discloses an epoxy resin composition including an epoxy resin, a curing agent, and a silica. The silica is treated with an imidazole silane, and the mean particle diameter of the silica is equal to or less than 5 μm. By curing the epoxy resin composition, and then performing a roughening treatment thereon, the silica can be easily eliminated without etching the resin to a large degree. Therefore, the surface roughness of the surface of the cured object can be reduced. In addition, adhesiveness between the cured object and a copper plating can be increased.

### CITATION LIST

### Patent Literature

[PTL 1] Japanese Laid-Open Patent Publication No. H09-169871
[PTL 2] Japanese Laid-Open Patent Publication No. 2002-128872
[PTL 3] WO2007/032424 Official Report
[PTL 1] Japanese Laid-Open Patent Publication No. 2003-000000

### SUMMARY OF THE INVENTION

### Problems to be Solved by the Invention

Wirings of metals such as copper are often formed on the surfaces of the cured bodies obtained by using the above described thermosetting resin compositions. In recent years, miniaturization is progressing for wirings formed on the surfaces of such cured bodies. Namely, there are further decreases in L/S, in which a dimension (L) is a width direction of wirings and dimension (S) is a width direction of a portion on which wirings are not formed. Therefore, further decrease in the linear expansion coefficient of a cured body has been discussed. Conventionally, a large amount of an inorganic filler such as silica has generally been blended in a thermosetting resin composition in order to reduce the linear expansion coefficient of a cured body.

However, when a large amount of an inorganic filler is blended in, the inorganic filler can easily aggregate. Therefore, during a roughening treatment, the aggregated inorganic filler is eliminated as a lump, and thereby increasing the surface roughness.

Thermosetting resin compositions disclosed in patent literatures 1 to 3 include substances obtained by performing a surface treatment on a filler or an inorganic filler such as silica using an imidazole silane. Even when such a surface-treated substance is used, there are cases where the surface roughness is not reduced for the surface of a cured body obtained by performing a roughening treatment. Furthermore, even when the surface roughness of the surface of the cured body is reduced, if a metal plating is provided on the cured body, the post-roughened adhesive strength between the cured body and the metal plating has not been sufficient.

An objective of the present invention is to provide a laminated body including a cured body layer, and a method for producing the laminated body, wherein the laminated body is capable of reducing the surface roughness of the surface of the cured body layer obtained by performing a roughening treatment, and when a metal layer such as a metal plating layer is formed on the surface of the cured body layer obtained by performing a roughening treatment, the laminated body is capable of increasing the adhesive strength between the cured body layer and the metal layer.

### Solution to the Problems

A broad aspect of the present invention provides a laminated body comprising a substrate and a cured body layer laminated on the substrate. The cured body layer is formed by laminating a resin film on the substrate, preliminary-curing the resin film at 100° C. to 200° C. to form a preliminary-cured body layer, and performing a roughening treatment on the surface of the preliminary-cured body layer at 55° C. to 80° C. The resin film includes an epoxy resin, a curing agent, a curing accelerator, and a surface treated substance obtained by performing a surface treatment, using 0.5 to 3.5 parts by weight of a silane coupling agent, on 100 parts by weight of an inorganic filler with a mean particle diameter of 0.05 to 1.5 μm. Furthermore, the resin film is formed from a resin composition in which a contained amount of the surface treated substance is within a range from 10 wt % to 80 wt % in a total 100 wt % of the epoxy resin, the curing agent, the curing accelerator, and the surface treated substance. The silane coupling agent includes a functional group that can react with the epoxy resin or the curing agent, and the functional group is an epoxy group, an imidazole group, or an amino group.

In a specific aspect of the laminated body according to the present invention, the curing agent is at least one type selected from the group consisting of phenolic compounds having a biphenyl structure, phenolic compounds having a naphthalene structure, phenolic compounds having a dicyclopentadiene structure, phenolic compounds having an aminotriazine structure, active ester compounds, and cyanate ester resins.

In another specific aspect of the laminated body according to the present invention, an imidazole silane compound is included in the resin composition within a range from 0.01 to 3 parts by weight with regard to a total 100 parts by weight of the epoxy resin and the curing agent.

In another specific aspect of the laminated body according to the present invention, the surface of the cured body layer, on which a roughening treatment is performed, has an arithmetic mean roughness Ra equal to or less than 300 nm and a ten-point mean roughness Rz equal to or less than 3 μm.

In another specific aspect of the laminated body according to the present invention, with regard to the resin film, a swelling treatment is performed on the preliminary-cured body at 50° C. to 80° C., after the preliminary-curing but before the roughening treatment.

Another broad aspect of the present invention provides a method for producing a laminated body including a substrate and a cured body layer laminated on the substrate. The method comprises: a step of laminating a resin film on the substrate to form the cured body layer; a step of preliminary-curing the resin film laminated on the substrate at 100° C. to 200° C. to form a preliminary-cured body layer; and a step of performing a roughening treatment on the surface of the preliminary-cured body layer at 55° C. to 80° C. to form a roughening-treated cured body layer. The resin film includes an epoxy resin, a curing agent, a curing accelerator, and a surface treated substance obtained by performing a surface treatment, using 0.5 to 3.5 parts by weight of a silane coupling agent, on 100 parts by weight of an inorganic filler with a mean particle diameter of 0.05 to 1.5 μm. The resin film is formed using a resin composition in which a contained amount of the surface treated substance is within a range from 10 wt % to 80 wt % in a total 100 wt % of the epoxy resin, the curing agent, the curing accelerator, and the surface treated substance. The silane coupling agent is a silane coupling agent that includes a functional group that can react with the epoxy resin or the curing agent, and the functional group is an epoxy group, an imidazole group, or an amino group.

In a specific aspect of the method for producing the laminated body according to the present invention, the curing agent used therein is at least one type selected from the group consisting of phenolic compounds having a biphenyl structure, phenolic compounds having a naphthalene structure, phenolic compounds having a dicyclopentadiene structure, phenolic compounds having an aminotriazine structure, active ester compounds, and cyanate ester resins.

In another specific aspect of the method for producing the laminated body according to the present invention, the resin composition used therein is a resin composition including an imidazole silane compound within a range from 0.01 to 3 parts by weight with regard to a total 100 parts by weight of the epoxy resin and the curing agent.

In another specific aspect of the method for producing the laminated body according to the present invention, the amount of time for a roughening treatment at the step of performing a roughening treatment is 5 to 30 minutes.

Another specific aspect of the method for producing the laminated body according to the present invention, further comprises a step of performing a swelling treatment on the surface of the preliminary-cured body layer at 50° C. to 80° C., after the step of preliminary-curing but before the step of performing a roughening treatment.

In still another specific aspect of the method for producing the laminated body according to the present invention, the amount of time for a swelling treatment at the step of performing a swelling treatment is 5 to 30 minutes.

In still another specific aspect of the method for producing the laminated body according to the present invention, at the step of laminating, a lamination temperature is 70° C. to 130° C., and a lamination pressure is 0.1 to 2.0 MPa.

### ADVANTAGEOUS EFFECTS OF THE INVENTION

A laminated body and a method for producing the laminated body according to the present invention allows reduction of the surface roughness of the surface of a cured body layer obtained by performing a roughening treatment, since the cured body layer is formed by using a resin composition including an epoxy resin, a curing agent, and a curing accelerator, in addition to the above described specific contained amount of a surface treated substance obtained by performing a surface treatment using the above described specific amount of a silane coupling agent on an inorganic filler with a mean particle diameter of 0.05 to 1.5 μm, and since the silane coupling agent includes the above described specific functional group that can react with the epoxy resin and the curing agent, and since a preliminary-curing temperature is 100° C. to 200° C. and a roughening treatment temperature is 55° C. to 80° C. when forming the cured body layer. Furthermore, when a metal layer such as a metal plating layer is formed on the surface of the cured body layer obtained by performing a roughening treatment, the adhesive strength between the cured body and the metal layer can be increased.

### BRIEF DESCRIPTION OF THE DRAWINGS

FIG. 1 is a partially-cut front sectional view showing a lamination film used for obtaining a laminated body according to one embodiment of the present invention.

FIG. 2 is a partially-cut front sectional view schematically showing a multilayer printed wiring board in which a laminated body according to one embodiment of the present invention is applied.

FIG. 3(a) to FIG. 3(d) of are partially-cut front sectional views for describing each step for producing a multilayer printed wiring board in which a laminated body according to one embodiment of the present invention is applied.

FIG. 4 is an enlarged partially-cut front sectional view schematically showing the surface of a cured body layer obtained by performing a roughening treatment.

FIG. 5 This is an enlarged partially-cut front sectional view showing a state in which a metal layer is formed on the surface of the cured body layer obtained by performing a roughening treatment.

### DESCRIPTION OF EMBODIMENTS

The inventors of the present application have discovered that the surface roughness of the surface of a cured body layer obtained by performing a roughening treatment can be reduced and that the adhesive strength between the cured body layer and a metal layer can be increased, by forming the cured body layer using a resin composition including a composition that includes an epoxy resin, a curing agent, and a curing accelerator, in addition to the above described specific contained amount of a surface treated substance obtained by performing a surface treatment using the above described specific amount of a silane coupling agent on an inorganic filler with a mean particle diameter of the above described 0.05 to 1.5 μm, and by having a preliminary-curing temperature to be 100° C. to 200° C. and a roughening treatment temperature to be 55° C. to 80° C. when forming the cured body layer; and thereby the inventors have perfected the present invention.

The inventors of the present application have discovered that there is a clear correlation between a roughening treatment temperature and an interfacial area between a resin component and a surface treated substance, which is defined by a mean particle diameter of an inorganic filler, and that a small surface roughness and a large adhesive strength can both be achieved at high levels by having the above described configuration of the present invention. The roughening treatment temperature is related to a degree of etching a resin component is subjected to, and by designing the degree of etching and the mean particle diameter of the inorganic filler in optimal ranges, a conventional difficulty of achieving both a small surface roughness and a large adhesive strength is made possible.

When a roughening treatment is performed, it is assumed that a surface treated substance is eliminated and a rough surface is formed, as a result of a roughening liquid penetrating an interface between the resin component and the surface treated substance on the surface of the preliminary-cured body layer, and thereby roughening the resin component in proximity of the interface between the surface treated substance and the resin component.

At the interface between the surface treated substance and the resin component, the above described functional group of the silane coupling agent acts on the resin component in proximity of the surface of the surface treated substance, and suppresses the resin component in proximity of the surface of the surface treated substance from being roughened more than necessary. Therefore, the surface roughness can be easily controlled by using the surface treated substance.

Since the resin component in proximity of the portion, in which the surface treated substance is eliminated, is not roughened (degraded) more than necessary, a large adhesive strength can be expected even when a metal layer is formed on the surface of the cured body layer.

It is assumed that the roughening liquid penetrates the interface between the resin and the surface treated substance on the surface of the preliminary-cured body layer when a roughening treatment is performed. Therefore, the interfacial area of the surface treated substance is important, and the roughening liquid easily penetrates the interface between the resin component and the surface treated substance by using an inorganic filler having a mean particle diameter of 0.05 to 1.5 μm. As a result, if a swelling treatment is to be performed, a swelling liquid can penetrate easily.

In the following, first, a resin composition used for forming a cured body layer of a laminated body according to the present invention will be described.

The resin composition used for forming the cured body layer includes an epoxy resin, a curing agent, a curing accelerator, and a surface treated substance obtained by performing a surface treatment, using 0.5 to 3.5 parts by weight of a silane coupling agent, on 100 parts by weight of an inorganic filler with a mean particle diameter of 0.05 to 1.5 μm. The surface treated substance is included within a range from 10 wt % to 80 wt % in a total 100 wt % of the epoxy resin, the curing agent, the curing accelerator, and the surface treated substance. The silane coupling agent includes a functional group that can react with the epoxy resin or the curing agent. The functional group is an epoxy group, an imidazole group, or an amino group.

(Epoxy Resin)

An epoxy resin included in the resin composition is an organic compound including at least one epoxy group (oxirane ring). The number of epoxy groups in a single molecule of the epoxy resin is equal to or more than one. The number of the epoxy groups is preferably equal to or more than two.

A conventionally well-known epoxy resin can be used as the epoxy resin. With regard to the epoxy resin, a single type may be used by itself, or a combination of two or more types may be used. The epoxy resin also includes an epoxy resin derivative and a hydrogenated compound of an epoxy resin.

The epoxy resin includes, for example, an aromatic epoxy resin (1), an alicyclic epoxy resin (2), an aliphatic epoxy resin (3), a glycidyl ester type epoxy resin (4), a glycidyl amine type epoxy resin (5), a glycidyl acrylic type epoxy resin (6), an polyester type epoxy resin (7), or the like.

The aromatic epoxy resin (1) includes, for example, a bisphenol type epoxy resin, a novolac type epoxy resin, or the like.

The bisphenol type epoxy resin includes, for example, a bisphenol A type epoxy resin, a bisphenol F type epoxy resin, a bisphenol AD type epoxy resin, a bisphenol S type epoxy resin, or the like.

The novolac type epoxy resin includes a phenol novolac type epoxy resin, a cresol novolac type epoxy resin, or the like.

Furthermore, as the aromatic epoxy resin (1), an epoxy resin or the like having, in a main chain, an aromatic ring such as naphthalene, naphtylene ether, biphenyl, anthracene, pyrene, xanthene, or indole, can be used. Additionally, an indole-phenol co-condensation epoxy resin, a phenol aralkyl type epoxy resin, or the like can be used. In addition, an epoxy resin or the like consisting of an aromatic compound such as a trisphenol-methane triglycidyl ether can be used.

The alicyclic epoxy resin (2) includes, for example, 3,4-epoxy cyclohexylmethyl-3,4-epoxy cyclohexane carboxylate, 3,4-epoxy-2-methylcyclohexylmethyl-3,4-epoxy-2-methylcyclohexane carboxylate, bis(3,4-epoxy cyclohexyl)adipate, bis(3,4-epoxy cyclohexylmethyl)adipate, bis(3,4-epoxy-6-methylcyclohexylmethyl)adipate, 2-(3,4-epoxy cyclohexyl-5,5-spiro-3,4-epoxy)cyclohexanone-m-dioxane, bis(2,3-epoxy cyclopentyl)ether, or the like.

Commercial items of the alicyclic epoxy resin (2) include, for example, “EHPE-3150” (softening temperature 71° C.), which is a product name and which is manufactured by Daicel Chemical Industries, Ltd., or the like.

The aliphatic epoxy resin (3) includes, for example, a diglycidyl ether of neo pentylglycol, a diglycidyl ether of 1,4-butanediol, a diglycidyl ether of 1,6-hexanediol, a triglycidyl ether of glycerin, a triglycidyl ether of trimethylolpropane, a diglycidyl ether of polyethylene glycol, a diglycidyl ether of polypropylene glycol, a poly glycidyl ether of a long chain polyol, or the like.

The long chain polyol preferably includes a poly oxyalkylene glycol or poly tetramethylene ether glycol. Furthermore, the carbon number of an alkylene group of the polyoxyalkylene glycol is preferably within a range from 2 to 9, and more preferably within a range from 2 to 4.

The glycidyl ester type epoxy resin (4) includes, for example, phthalic acid diglycidyl ester, tetrahydrophthalic acid diglycidyl ester, hexahydrophthalic acid diglycidyl ester, diglycidyl-p-oxybenzoic acid, a glycidyl ether-glycidyl ester of salicylic acid, a dimer acid glycidyl ester, or the like.

The glycidyl amine type epoxy resin (5) includes, for example, triglycidyl isocyanurate, a N,N′-diglycidyl derivative of cyclic alkylene urea, a N,N,O-triglycidyl derivative of p-aminophenol, a N,N,O-triglycidyl derivative of m-aminophenol, or the like.

The glycidyl acrylic type epoxy resin (6) includes, for example, a copolymer of glycidyl (meth)acrylate and a radical polymerizable monomer, or the like. The radical polymerizable monomer includes ethylene, vinyl acetate, a (meth)acrylic ester, or the like.

The polyester type epoxy resin (7) includes, for example, a polyester resin having an epoxy group, or the like. The polyester resin preferably includes two or more epoxy groups in a single molecule.

As the epoxy resin, other than the epoxy resins (1) to (7), epoxy resins (8) to (11) shown in the following may be used.

The epoxy resin (8) includes, for example: a compound obtained by modifying, through epoxidation, a carbon-carbon double bond of a (co)polymer having a conjugated diene compound as a main body thereof; a compound obtained by modifying, through epoxidation, a carbon-carbon double bond of a partially hydrogenated compound of a (co)polymer having a conjugated diene compound as a main body thereof; or the like. Specific examples of the epoxy resin (8) include a polybutadiene modified by epoxidation, a dicyclopentadiene modified by epoxidation, or the like.

The epoxy resin (9) includes: a compound obtained by modifying, through epoxidation, a carbon-carbon double bond of a block copolymer including, in the same molecule, a polymeric block having a vinyl aromatic compound as a main body thereof, and a polymeric block having a conjugated diene compound as a main body thereof or a partially hydrogenated compound of the polymeric block; or the like. Examples of such compounds include SBS modified by epoxidation or the like.

The epoxy resin (10) includes, for example, a urethane modified epoxy resin obtained by introducing a urethane bond in the structures of the epoxy resins of (1) to (9), or a polycaprolactone modified epoxy resin obtained by introducing a polycaprolactone bond in the structures of the epoxy resins of (1) to (9).

The epoxy resin (11) includes an epoxy resin or the like having a bisaryl fluorene backbone.

Commercial items of the epoxy resin (11) include, for example, “On-coat EX series”, which is a product name and which is manufactured by Osaka Gas Chemicals Co., Ltd., or the like.

Furthermore, a flexible epoxy resin may be suitably used as the epoxy resin. Using the flexible epoxy resin can increase flexibility of the cured body.

The flexible epoxy resin includes: a diglycidyl ether of polyethylene glycol; a diglycidyl ether of polypropylene glycol; a poly glycidyl ether of a long chain polyol; a copolymer of glycidyl(meth)acrylate and a radical polymerizable monomer; a polyester resin including epoxy group; a compound obtained by modifying, through epoxidation, a carbon-carbon double bond of a (co)polymer having a conjugated diene compound as a main body thereof; a compound obtained by modifying, through epoxidation, a carbon-carbon double bond of a partially hydrogenated compound of a (co)polymer having a conjugated diene compound as a main body thereof; a urethane modified epoxy resin; a polycaprolactone modified epoxy resin; or the like.

Furthermore, the flexible epoxy resin includes a dimer acid modified epoxy resin obtained by introducing an epoxy group within a molecule of a dimer acid or a derivative of a dimer acid, a rubber modified epoxy resin obtained by introducing an epoxy group within a molecule of a rubber ingredient, or the like.

The rubber ingredient includes NBR, CTBN, polybutadiene, acrylic rubber, or the like.

The flexible epoxy resin preferably has a butadiene backbone. By using the flexible epoxy resin having a butadiene backbone, flexibility of the cured body can be further increased. In addition, the rate of elongation of the cured body can be increased in a broad temperature range from a low temperature range to a high temperature range.

As the epoxy resin, a biphenyl type epoxy resin, a naphthalene type epoxy resin, an anthracene type epoxy resin, an adamantane type epoxy resin, or a triglycidyl isocyanurate may be used. The biphenyl type epoxy resin includes a compound or the like obtained by substituting a part of hydroxyl groups of a phenolic compound with groups containing an epoxy group, and by substituting the remaining hydroxyl groups with substituent groups other than hydroxyl group such as hydrogen. By using these epoxy resins including a rigid ring structure, such as a biphenyl type epoxy resin, a naphthalene type epoxy resin, an anthracene type epoxy resin, or an adamantane type epoxy resin, the linear expansion coefficient of the cured body can be reduced. Furthermore, by using epoxy resins including such as triglycidyl isocyanurate, which is multi-functional and which has a triazine ring, the linear expansion coefficient of the cured body can be effectively reduced.

The epoxy equivalent of the epoxy resin is preferably within a range from 100 to 500. If the epoxy equivalent is less than 100, the preservation stability of the resin composition and the preliminary-cured body obtained by preliminary-curing the resin composition can be significantly reduced, since reaction of the epoxy resin easily proceeds. If the epoxy equivalent is larger than 500, reaction of the epoxy resin will have difficulty proceeding, and curing of the resin composition may not proceed sufficiently.

Preferably, in a total 100 wt % of the epoxy resin, the curing agent, the curing accelerator, and the surface treated substance, 15 wt % to 80 wt % is liquid at 25° C. More preferably, in a total 100 wt % of the epoxy resin, the curing agent, the curing accelerator, and the surface treated substance, 25 wt % or higher is liquid at 25° C. Further preferably, in a total 100 wt % of components other than a solvent in the resin composition, 20 wt % or higher of the total is liquid. If the contained amount of components liquid at 25° C. is too small, the resin composition in a B stage state becomes fragile, and can crack when being bent.

The epoxy resin is preferably a liquid epoxy resin that is liquid at 25° C.

A bisphenol A type epoxy resin or a bisphenol F type epoxy resin is suitably used as the liquid epoxy resin. Among these, a bisphenol A type epoxy resin is more preferable.

The viscosity of the liquid epoxy resin at 25° C. is preferably within a range from 0.1 to 100 Pa·s. If the viscosity is smaller than 0.1 Pa·s, the resin film tends to become thin when laminated or press-molded. If the viscosity is larger than 100 Pa·s, it may deteriorate the handling performance of a resin film.

When a solvent is not included in the resin composition, the contained amount of the epoxy resin is preferably equal to or higher than 20 wt % in a total 100 wt % of components included in the resin composition. When a solvent is included in the resin composition, the contained amount of the epoxy resin is preferably equal to or higher than 20 wt % in a total 100 wt % of the components excluding the solvent included in the resin composition. If the contained amount of the epoxy resin is lower than 20 wt %, it may deteriorate the handling performance of the resin film.

(Curing Agent)

There is no particular limitation in the curing agent included in the resin composition. The curing agent includes, for example, dicyandiamide, an amine compound, a compound synthesized from an amine compound, a hydrazide compound, a melamine compound, an acid anhydride, a phenolic compound (phenol curing agent), an active ester compound, a benzoxazine compound, a maleimide compound, a heat latent cationic polymerization catalyst, a light latent cationic polymerization initiator, a cyanate ester resin, or the like. Derivatives of these curing agents may also be used. With regard to the curing agent, a single type may be used by itself, or a combination of two or more types may be used.

The amine compound includes, for example, a linear aliphatic amine compound, a cyclic aliphatic amine compound, an aromatic amine compound, or the like.

The linear aliphatic amine compound includes, for example, ethylene diamine, diethylene triamine, triethylene tetramine, tetraethylene pentamine, polyoxypropylene diamine, polyoxypropylene triamine, or the like.

The cyclic aliphatic amine compound includes, for example, menthene diamine, isophorone diamine, bis(4-amino-3-methylcyclohexyl)methane, diaminodicyclohexylmethane, bis(aminomethyl)cyclohexane, N-aminoethyl piperazine, 3,9-bis(3-aminopropyl)-2,4,8,10-tetraoxaspiro(5,5)undecane, or the like.

The aromatic amine compound includes, for example, m-xylenediamine, α-(m/p-aminophenyl)ethylamine, m-phenylenediamine, diaminodiphenylmethane, diaminodiphenylsulfone, α,α-bis(4-aminophenyl)-p-diisopropylbenzene, or the like.

A tertiary amine compound may be used as the amine compound. The tertiary amine compound includes, for example, N,N-dimethylpiperazine, pyridine, picoline, benzyldimethylamine, 2-(dimethylamino methyl)phenol, 2,4,6-tris(dimethylamino methyl)phenol, 1,8-diazabiscyclo(5,4,0)undecene-1, or the like.

Specific examples of the compound synthesized from the amine compound include a polyamino-amide compound, a polyamino-imide compound, a ketimine compound, or the like.

The polyamino-amide compound includes, for example, a compound synthesized from the amine compound and a carboxylic acid, or the like. The carboxylic acid includes, for example, succinic acid, adipic acid, azelaic acid, sebacic acid, dodecanedioic acid, isophthalic acid, terephthalic acid, dihydroisophthalic acid, tetrahydroisophthalic acid, hexahydroisophthalic acid, or the like.

The polyamino-imide compound includes, for example, a compound synthesized from the amine compound and a maleimide compound, or the like. The maleimide compound includes, for example, diaminodiphenylmethane bismaleimide or the like.

The ketimine compound includes, for example, a compound synthesized from the amine compound and a ketone compound, or the like.

Other specific examples of the compound synthesized from the amine compound include a compound synthesized from the amine compound, and an epoxy compound, a urea compound, a thiourea compound, an aldehyde compound, a phenolic compound, or an acrylic compound.

The hydrazide compound includes, for example, 1,3-bis(hydrazinocarboethyl)-5-isopropylhydantoin, 7,11-octadecadiene-1,18-dicarbohydrazide, eicosanedioic acid dihydrazide, adipic acid dihydrazide, or the like.

The melamine compound includes, for example, 2,4-diamino-6-vinyl-1,3,5-triazine, or the like.

The acid anhydride includes, for example, phthalic anhydride, trimellitic anhydride, pyromellitic anhydride, benzophenone tetracarboxylic anhydride, ethylene glycol bisanhydro trimellitate, glycerol trisanhydro trimellitate, methyl tetrahydrophthalic anhydride, tetrahydrophthalic anhydride, nadic anhydride, methyl nadic anhydride, trialkyl tetrahydrophthalic anhydride, hexahydrophthalic anhydride, methyl hexahydrophthalic anhydride, 5-(2,5-dioxotetrahydro furil)-3-methyl-3-cyclohexene-1,2-dicarboxylic anhydride, an adduct of trialkyl tetrahydrophthalic anhydride-maleic anhydride, dodecenyl succinic anhydride, polyazelaic anhydride, polydodecanedioic anhydride, chlorendic anhydride, or the like.

The heat latent cationic polymerization catalyst includes, for example, an ionic heat latent cationic polymerization catalyst, or a nonionic heat latent cationic polymerization catalyst.

The ionic heat latent cationic polymerization catalyst includes a benzylsulfonium salt, a benzylammonium salt, a benzylpyridinium salt, a benzylsulfonium salt, or the like having, as a counter-anion, antimony hexafluoride, phosphorus hexafluoride, boron tetrafluoride, or the like.

The nonionic heat latent cationic polymerization catalyst includes N-benzyl phthalimide, an aromatic sulphonic acid ester, or the like.

The light latent cationic polymerization catalyst includes, for example, an ionic light latent cationic polymerization initiator, or a nonionic light latent cationic polymerization initiator.

Specific examples of the ionic light latent cationic polymerization initiator include onium salts, organometallic complexes, or the like. The onium salts include, for example, an aromatic diazonium salt, an aromatic halonium salt, an aromatic sulfonium salt, or the like having, as a counter-anion, antimony hexafluoride, phosphorus hexafluoride, boron tetrafluoride, or the like. The organometallic complexes include, for example, an iron-allene complex, a titanocene complex, an aryl silanol-aluminium complex, or the like.

Specific examples of the nonionic light latent cationic polymerization initiator include a nitrobenzyl ester, a sulfonic acid derivative, a phosphate ester, a phenolsulfonic acid ester, diazonaphthoquinone, N-hydroxyimide sulfonate, or the like.

The phenolic compound includes, for example, a phenol novolac, an o-cresol novolac, a p-cresol novolac, a t-butyl phenol novolac, dicyclopentadiene cresol, a phenol aralkyl resin, an α-naphthol aralkyl resin, a β-naphthol aralkyl resin, an amino triazine novolac resin, or the like. Derivatives of these may be used as the phenolic compound. With regard to the phenolic compound, a single type may be used by itself, or a combination of two or more types may be used.

The phenolic compound (phenol curing agent) may be suitably used as the curing agent. By using the phenolic compound, the heat resistance and the dimensional stability of the cured body can be increased, and water absorptivity of the cured body can also be reduced. Furthermore, the surface roughness of the surface of the cured body obtained by performing a roughening treatment can be further reduced. Specifically, the arithmetic mean roughness Ra and the ten-point mean roughness Rz of the surface of the roughening-treated cured body can be further reduced.

A phenolic compound represented by any one of the following formula (1), formula (2), or formula (3) is more suitably used as the curing agent. In this case, the surface roughness of the surface of the cured body can be further reduced.

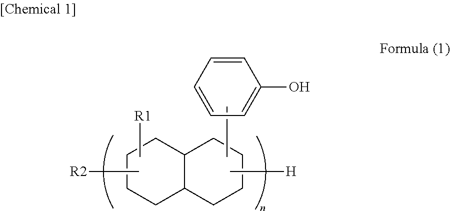

In the above described formula (1), R1 represents a methyl group or an ethyl group, R2 represents a hydrogen or a hydrocarbon group, and n represents an integer of 2 to 4.

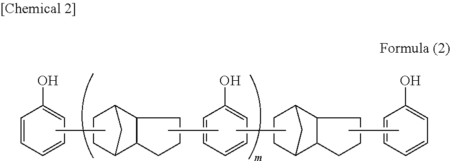

In the above described formula (2), m represents an integer of 0 to 5.

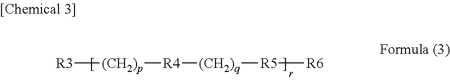

In the above described formula (3), R3 indicates a group represented by the following formula (4a) or formula (4b), R4 indicates a group represented by the following formula (5a), formula (5b), or formula (5c), R5 indicates a group represented by the following formula (6a) or formula (6b), R6 indicates a hydrogen or an organic group having a carbon number of 1 to 20, p represents an integer of 1 to 6, q represents an integer of 1 to 6, and r represents an integer of 1 to 11.

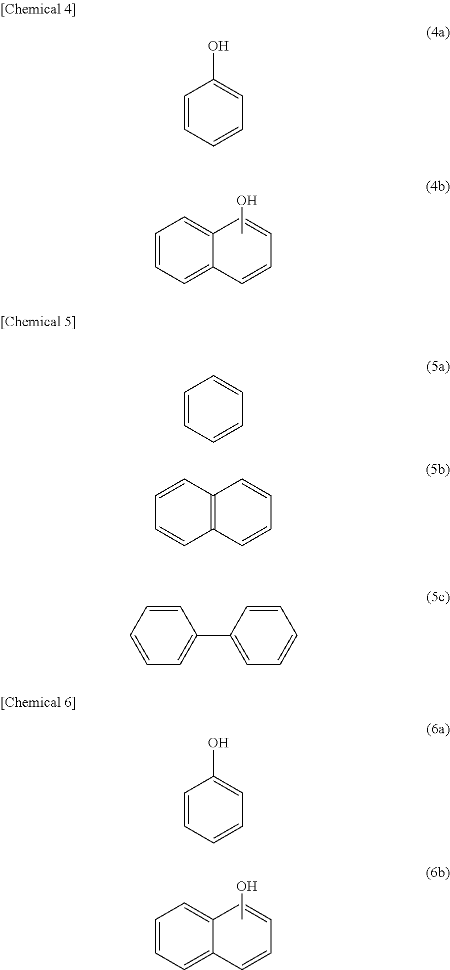

Among those, the phenolic compound having a biphenyl structure, which is a phenolic compound represented by the formula (3) and in which R4 in the formula (3) is a group represented by the formula (5c), is preferable. By using this preferable curing agent, the electrical property and the heat resistance of the cured body can be further increased, and the linear expansion coefficient and water absorptivity of the cured body can be further reduced. Furthermore, in case a thermal history is to be given to the cured body, the dimensional stability thereof can be further increased.

A phenolic compound having the structure shown in the following formula (7) is particularly preferable as the curing agent. In this case, the electrical property and the heat resistance of the cured body can be further increased, and the linear expansion coefficient and water absorptivity of the cured body can be further reduced. Furthermore, in case a thermal history is to be given to the cured body, the dimensional stability thereof can be further increased.

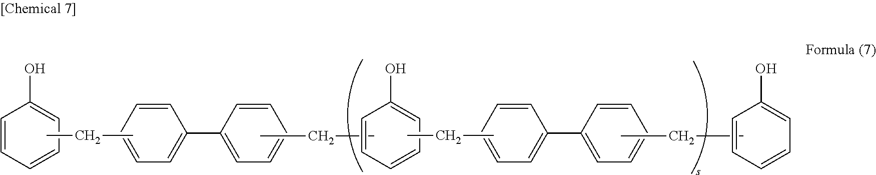

In the above described formula (7), s represents an integer of 1 to 11.

The active ester compound includes, for example, an aromatic multivalent ester compound or the like. When an active ester compound is used, a cured body having excellent dielectric constant and dielectric loss tangent can be obtained, since an OH group is not generated at the time of a reaction between the active ester group and the epoxy resin. Specific examples of the active ester compound are disclosed in, for example, Japanese Laid-Open Patent Publication No. 2002-12650.

Commercial items of the active ester compound include, for example, “EPICLON EXB9451-65T”, “EPICLON EXB9460S-65T”, and the like, which are product names and which are manufactured by DIC Corp.

The benzoxazine compound includes an aliphatic benzoxazine resin or an aromatic benzoxazine resin.

Commercial items of the benzoxazine compound include, for example, “P-d type benzoxazine” and “F-a type benzoxazine”, which are product names and which are manufactured by Shikoku Chemicals Corp., and the like.

For example, a novolac type cyanate ester resin, a bisphenol type cyanate ester resin, a prepolymer having one part thereof modified to have a triazine structure, and the like can be used as the cyanate ester resin. By using the cyanate ester resin, the linear expansion coefficient of the cured body can be further reduced.

The maleimide compound is preferably at least one type selected from the group consisting of N,N′-4,4-diphenylmethane bismaleimide, N,N′-1,3-phenylene dimaleimide, N,N′-1,4-phenylene dimaleimide, 1,2-bis(maleimide) ethane, 1,6-bismaleimide hexane, bis(3-ethyl-5-methyl-4-maleimide phenyl)methane, polyphenylmethane maleimide, bisphenol A diphenyl ether bismaleimide, 4-methyl-1,3-phenylene bismaleimide, 1,6-bismaleimide-(2,2,4-trimethyl) hexane, oligomers of these, and maleimide-backbone-containing diamine condensates. By using these preferable maleimide compounds, the linear expansion coefficient of the cured body can be further reduced, and the glass transition temperature of the cured body can be further increased. The above described oligomer is an oligomer obtained by condensating a maleimide compound which is a monomer among the above described maleimide compounds.

Among those, the maleimide compound is more preferably at least one of polyphenylmethane maleimide or a bismaleimide oligomer. The bismaleimide oligomer is preferably an oligomer obtained by condensating phenylmethane bismaleimide and 4,4-diaminodiphenylmethane. By using these preferably maleimide compounds, the linear expansion coefficient of the cured body can be further reduced, and the glass transition temperature of the cured body can be further increased.

Commercial items of the maleimide compound include polyphenylmethane maleimide (product name “BMI-2300” manufactured by Daiwa Fine Chemicals Co., Ltd.), a bismaleimide oligomer (product name “DAIMAID-100H” manufactured by Daiwa Fine Chemicals Co., Ltd.), and the like.

BMI-2300 manufactured by Daiwa Fine Chemicals Co., Ltd. is a low molecular weight oligomer. DAIMAID-100H manufactured by Daiwa Fine Chemicals Co., Ltd. is a condensate obtained by using diaminodiphenylmethane as an amine curing agent, and has a high molecular weight. If DAIMAID-100H is used instead of BMI-2300, the breaking strength and the breaking point elongation rate of the cured body can be increased.

In the present invention, as the curing agent, at least one type among the phenol curing agent, the active ester compound, and the cyanate ester resin may be suitably used.

The phenol curing agent displays a high reaction activity to an epoxy group. Furthermore, when the phenol curing agent described above is used, the glass transition temperature Tg of the cured body can be raised relatively highly, and the chemical resistance of the cured body can be increased.

When the active ester compound or the benzoxazine compound is used as the curing agent, a cured body having even better dielectric constant and dielectric loss tangent can be obtained. The active ester compound is preferably an aromatic multivalent ester compound. By using the aromatic multivalent ester compound, a cured body having even better dielectric constant and dielectric loss tangent can be obtained.

When the active ester compound is used as the curing agent, advantageous effects such as even better dielectric constant and dielectric loss tangent, and a superior fine-wiring formability are obtained. Therefore, for example, when the resin composition is used as an insulator for build-ups, an advantageous effect of having a superior signal transmission particularly in a high frequency range can be expected.

The curing agent is preferably at least one type selected from the group consisting of phenolic compounds having a biphenyl structure, phenolic compounds having a naphthalene structure, phenolic compounds having a dicyclopentadiene structure, phenolic compounds having an aminotriazine structure, active ester compounds, and cyanate ester resins. The curing agent is more preferably at least one type selected from the group consisting of biphenyl type phenol curing agents, naphthol curing agents, and active ester compounds; and biphenyl type phenol curing agents are particularly preferable. By using these preferable curing agents, the resin component is even more unlikely to be subjected to adverse influences during a roughening treatment. Specifically, during a roughening treatment, fine holes can be formed without excessively roughening the surface of the cured body by selectively eliminating the surface treated substance. Thus, fine concavities and convexities with a very small surface roughness can be formed on the surface of the cured body.

The phenol curing agent preferably includes two or more hydroxyl groups in a single molecule. In such case, the strength and heat resistance of the cured body can be increased.

The weight average molecular weight of the curing agent, and in particular the weight average molecular weight of the phenol curing agent is preferably within a range from 1000 to 20000. If the weight average molecular weight is within the range described above, solubility of the curing agent to the solvent increases, and the heat resistance and strength of the cured body can be increased.

The weight average molecular weight described above is a polystyrene-equivalent weight average molecular weight measured by gel permeation chromatography (GPC).

The softening point of the curing agent, and in particular the softening point of the phenol curing agent is preferably equal to or higher than 50° C. If the softening point is lower than 50° C., there are cases where the performance of the cured body cannot sufficiently be increased, since the molecular weight of the curing agent tends to be small. A preferable upper limit of the softening point is 100° C. If the softening point is higher than 100° C., the curing agent may not be dissolved in the solvent when preparing the resin composition.

In a total 100 wt % of the epoxy resin, the curing agent, the curing accelerator, and the surface treated substance, a lower limit of the total contained amount of the epoxy resin and the curing agent is preferably equal to or lower than 40 wt %. If the total contained amount of the epoxy resin and the curing agent is too low, when the resin composition is applied on a base material film to form a resin film, the resin film will have a deteriorated handling performance. If the handling performance of the resin film deteriorates, the resin film is easily cracked when being bent, and scraps of the resin film easily adheres to manufacturing devices and the like. In a total 100 wt % of the epoxy resin, the curing agent, the curing accelerator, and the surface treated substance, a lower limit of the total contained amount of the epoxy resin and the phenol curing agent is more preferably 50 wt %, and a further preferable lower limit is 55 wt %, and a particularly preferable lower limit is 60 wt %, and a preferable upper limit is 90 wt %, and a more preferable upper limit is 80 wt %.

The blend ratio (epoxy resin/curing agent) with regard to the epoxy resin and the curing agent is preferably within a range from 1.0 to 2.5 in terms of ratio by weight. If the above described blend ratio is lower than 1.0, the contained amount of the epoxy resin is too low and the flatness of the surface of the cured body can be reduced. If the blend ratio is higher than 2.5, the contained amount of the curing agent is too low and unreacted epoxy resin tends to remain after curing, and the glass transition temperature and the linear-expansion-coefficient performance of the cured body can be reduced. A preferable lower limit of the blend ratio is 1.3, and a more preferable lower limit is 1.6, and a preferable upper limit is 2.4, and a more preferable upper limit is 2.2.

(Curing Accelerator)

There is no particular limitation in the curing accelerator included in the resin composition. With regard to the curing accelerator, a single type may be used by itself, or a combination of two or more types may be used.

The curing accelerator is preferably an imidazole compound. The curing accelerator is preferably at least one type selected from the group consisting of 2-undecylimidazole, 2-heptadecylimidazole, 2-methylimidazole, 2-ethyl-4-methylimidazole, 2-phenylimidazole, 2-phenyl-4-methylimidazole, 1-benzyl-2-methylimidazole, 1-benzyl-2-phenylimidazole, 1,2-dimethylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecyl imidazolium trimeritate, 1-cyanoethyl-2-phenyl imidazolium trimeritate, 2,4-diamino-6-[2′-methyl imidazolyl-(1′)]ethyl-s-triazine, 2,4-diamino-6-[2′-undecyl imidazolyl-(1′)]ethyl-s-triazine, 2,4-diamino-6-[2′-ethyl-4′-methyl imidazolyl-(1′)]-ethyl-s-triazine, adducts of 2,4-diamino-6-[2′-methyl imidazolyl-(1′)]-ethyl-s-triazine isocyanuric acid, adducts of 2-phenyl imidazole isocyanuric acid, adducts of 2-methyl imidazole isocyanuric acid, 2-phenyl-4,5-dihydroxymethylimidazole, and 2-phenyl-4-methyl-5-dihydroxymethylimidazole.

Furthermore, the curing accelerator includes a phosphine compound such as triphenyl phosphine, diazabicycloundecene (DBU), diazabicyclononene (DBN), a phenol salt of DBU, a phenol salt of DBN, an octylic acid salt, a p-toluenesulfonic acid salt, a formate, an orthophthalate, a phenol novolac resin salt, or the like.

In a total 100 wt % of the epoxy resin, the curing agent, the curing accelerator, and the surface treated substance, a preferable lower limit of the contained amount of the curing accelerator is 0.01 wt %, a more preferable lower limit is 0.1 wt %, and a further preferable lower limit is 0.2 wt %, and a preferable upper limit is 10 wt %, a more preferable upper limit is 5 wt %, and a further preferable upper limit is 3 wt %. If the contained amount of the curing accelerator is too low, curing of the resin composition does not proceed sufficiently, and it can result in a low Tg and a low strength of the cured body. If the contained amount of the curing accelerator is too high, even if the resin composition is cured, the molecular weight may not be sufficiently high, and crosslinks in the epoxy resin may become inhomogeneous, since there will be many reaction starting points. Additionally, preservation stability of the resin composition may deteriorate.

(Surface Treated Substance)

The resin composition includes a surface treated substance obtained by performing a surface treatment on an inorganic filler by using a silane coupling agent. With regard to the surface treated substance, a single type may be used by itself, or a combination of two or more types may be used.

The mean particle diameter of the inorganic filler is within a range from 0.05 to 1.5 μm. If the mean particle diameter is smaller than 0.05 μm, the surface treated substance easily aggregates and an unevenness state of the rough surface of the cured body can occur. Therefore, the adhesive strength between a metal layer and the roughening-treated cured body easily deteriorates. Furthermore, the viscosity of the resin composition increases, and the filling performance of the resin composition for through holes, via holes, or the like can deteriorate. If the mean particle diameter is larger than 1.5 μm, the surface roughness of the surface of the roughening-treated cured body tends to become large. In addition, when a roughening treatment is performed, it becomes difficult to eliminate the surface treated substance. Additionally, since a metal layer is formed on the surface of the cured body obtained by performing a roughening treatment, when a plate processing is conducted, plating liquid may sink into a void between the resin component and a surface treated substance that has not been eliminated. Therefore, the metal layer formed on the surface of cured body may become defective.

The mean particle diameter of the inorganic filler is preferably within a range from 0.2 to 1.5 μm. If the mean particle diameter is within the range described above, a further fine rough-surface may be formed on the surface of the cured body obtained by performing a roughening treatment.

Specific examples of the inorganic filler include, for example, aluminium nitride, alumina, boron nitride, titanium oxide, a mica, a mica powder, a clay, talc, silica, silicon nitride, or the like. The silica described above includes a fused silica, a crystal silica, or the like.

The maximum particle diameter of the inorganic filler is preferably equal to or smaller than 10 μm. If the maximum particle diameter is larger than 10 μm, when a patterned metal layer is formed on the surface of the cured body, a single rough surface (concaved portion) resulting from the elimination of the surface treated substance may be adjacent to two neighboring metal layers. Therefore, electrical properties among wirings may vary, and this may become a cause for malfunction or deteriorated reliability.

The inorganic filler is preferably a silica. The silica can be industrially acquired easily and inexpensively. By using the silica, the linear expansion coefficient of the cured body can be reduced, and heat dissipation properties of the cured body can be increased. The silica is preferably a fused silica.

With regard to the mean particle diameter described above, a value of median diameter (d50) representing 50% can be used. The mean particle diameter can be measured by using a particle-size-distribution measuring device utilizing laser diffraction dispersion method.

The specific surface area of the inorganic filler is preferably within a range from 10 to 70 m²/g. If the specific surface area is less than 10 m²/g, the adhesive strength between a metal layer and the roughening-treated cured body easily deteriorates. If it becomes difficult for the roughening liquid to penetrate the interface between the surface treated substance and the resin component, and if a roughening treatment is performed to a degree that allows elimination of the surface treated substance, the surface roughness of the surface of the cured body tends to become large. If the specific surface area is more than 70 m²/g, the surface roughness of the surface of the roughening-treated cured body tends to become large. Furthermore, the surface treated substance easily aggregates, and unevenness tends to be generated on the cured body.

The inorganic filler is surface-treated with a silane coupling agent. The silane coupling agent includes a functional group that can react with the epoxy resin and the curing agent. Therefore, when the resin composition is cured, the surface treated substance reacts with the epoxy resin or the curing agent, and the surface treated substance adequately adheres to the resin component in the preliminary-cured body. Thus, the surface roughness of the surface of the roughening-treated cured body can be reduced by performing a roughening treatment on the surface of the preliminary-cured body. Furthermore, the adhesive strength between a metal layer and the cured body can be increased.

The above described functional group of the silane coupling agent is an epoxy group, an imidazole group, or an amino group. Since such a functional group is included in the silane coupling agent, the surface roughness of the surface of the roughening-treated cured body can be reduced. Furthermore, the adhesive strength between a metal layer and the cured body can be further increased.

In the surface treated substance used in the present invention, 100 parts by weight of the inorganic filler is surface-treated using 0.5 to 3.5 parts by weight of the silane coupling agent. If the amount of the silane coupling agent is too small, the surface treated substance easily aggregates in the resin composition, and the surface roughness of the surface of the cured body tends to become large. If the amount of the silane coupling agent is too large, the curing can proceed easily and the preservation stability becomes inferior. Furthermore, the surface roughness of the surface of the cured body can easily become large. A preferable lower limit of the amount of the silane coupling agent used for performing a surface treatment is 1.0 parts by weight with regard to 100 parts by weight of the inorganic filler, and a preferable upper limit is 3.0 parts by weight, and a more preferable upper limit is 2.5 parts by weight.

In a total 100 wt % of the epoxy resin, the curing agent, the curing accelerator, and the surface treated substance, the contained amount of the surface treated substance is within a range from 5 to 80 wt %. If the contained amount of the surface treated substance is too low, the surface roughness of the surface of the roughening-treated cured body tends to become large. If the contained amount of the surface treated substance is too high, the surface roughness of the surface of the roughening-treated cured body tends to become large. Furthermore, since the resin film formed by the resin composition can easily become fragile, there will be cases where a sufficient handling performance of the resin film cannot be ensured. In a total 100 wt % of the epoxy resin, the curing agent, the curing accelerator, and the surface treated substance, a preferable lower limit of the contained amount of the surface treated substance is 10 wt %, and a more preferable lower limit is 15 wt %, and a preferable upper limit is 50 wt %, and a more preferable upper limit is 40 wt %. If the contained amount of the surface treated substance is too low, the adhesive strength between a metal layer and the cured body easily deteriorates. If the contained amount of the surface treated substance is too high, the surface roughness of the surface of the roughening-treated cured body easily deteriorates.

(Other Components that can be Added)

The resin composition described above preferably includes an imidazole silane compound. By using the imidazole silane compound, the surface roughness of the surface of the roughening-treated cured body can be further reduced.

The imidazole silane compound is preferably included within a range from 0.01 to 3 parts by weight with regard to a total of 100 parts by weight of the epoxy resin and the curing agent. If the contained amount of the imidazole silane compound is within the above described range, the surface roughness of the surface of the roughening-treated cured body can be further reduced, and the post-roughened adhesive strength between the cured body and the metal layer can be further increased. A more preferable lower limit of the contained amount of the imidazole silane compound is 0.03 parts by weight, and a more preferable upper limit is 2 parts by weight, and an even more preferable upper limit is 1 part by weight. When the contained amount of the curing agent is higher than 30 parts by weight to 100 parts by weight of the epoxy resin, it is particularly preferably to include the imidazole silane compound within a range from 0.01 to 2 parts by weight with regard to a total of 100 parts by weight of the epoxy resin and the curing agent.

The resin composition described above may include a solvent. As the solvent, a solvent having fine solubility of the resin component is selected as appropriate and used. With regard to the solvent, a single type may be used by itself, or a combination of two or more types may be used.

The solvent includes acetone, methyl ethyl ketone, toluene, xylene, n-hexane, methanol, ethanol, methyl cellosolve, ethyl cellosolve, butyl cellosolve, methoxy propanol, cyclohexanone, N-methylpyrrolidone, dimethylformamide, dimethyl acetamide, propylene glycol monomethyl ether, propylene glycol monomethyl ether acetate, ethylene glycol monomethyl ether acetate, or the like. The solvent is preferably dimethylformamide, methyl ethyl ketone, cyclohexanone, hexane, or propylene glycol monomethyl ether. By using any one of these preferably solvents, the resin component can be further easily dissolved in the solvent.

The blend amount of the solvent is selected as appropriate such that, for example, when the resin composition is applied on a base material film to form thereon the resin composition, the resin composition can be applied with an even thickness. In the resin composition including the epoxy resin, the curing agent, the curing accelerator, and the surface treated substance, with regard to a total 100 parts by weight of components other than a solvent, a preferable lower limit of the contained amount of the solvent is 30 parts by weight, a more preferable lower limit is 40 parts by weight, and a further preferable lower limit is 50 parts by weight, and a preferable upper limit is 200 parts by weight, a more preferable upper limit is 150 parts by weight, and a further preferable upper limit is 70 parts by weight, and a particularly preferable upper limit is 60 parts by weight. If the contained amount of the solvent is too low, the fluidity of the resin composition becomes too low, and the resin composition may not be possibly applied in an even thickness. If the contained amount of the solvent is too high, the fluidity of the resin composition becomes too high, and when the resin composition is applied, it wets and spreads more than necessary.

In addition to the epoxy resin, the resin composition may include a resin copolymerizable with the epoxy resin if necessary.

There is no particular limitation in the copolymerizable resin. The copolymerizable resin includes, for example, a phenoxy resin, a thermosetting modified-polyphenylene ether resin, a benzoxazine resin, or the like. With regard to the copolymerizable resin, a single type may be used by itself, or a combination of two or more types may be used.

Specific examples of the thermosetting modified-polyphenylene ether resin include resins or the like obtained by modifying a polyphenylene ether resin using functional groups such as epoxy group, isocyanate group, or amino group. With regard to the thermosetting modified-polyphenylene ether resin, a single type may be used by itself, or a combination of two or more types may be used.

Commercial items of the cured-type modified-polyphenylene ether resin obtained by modifying a polyphenylene ether resin using epoxy group include, for example, “OPE-2Gly”, which is a product name and which is manufactured by Mitsubishi Gas Chemical Co., Inc., or the like.

There is no particular limitation in the benzoxazine resin. Specific examples of the benzoxazine resin include: a resin in which a substituent group having a backbone of an aryl group such as methyl group, ethyl group, phenyl group, biphenyl group, or cyclohexyl group, is coupled to the nitrogen of an oxazine ring; a resin in which a substituent group having a backbone of an allylene group such as methylene group, ethylene group, phenylene group, biphenylene group, naphthalene group, or cyclohexylene group, is coupled in between the nitrogen atoms of two oxazine rings; or the like. With regard to the benzoxazine resin, a single type may be used by itself, or a combination of two or more types may be used. As a result of a reaction between the benzoxazine resin and the epoxy resin, the heat resistance of the cured body can be enhanced, and water absorptivity and the linear expansion coefficient can be reduced.

Note that, monomer or oligomer of benzoxazine, or a resin obtained by being given a high molecular weight by conducting a ring opening polymerization of the oxazine ring of monomer or oligomer of benzoxazine, is included in the benzoxazine resin.

Examples of additives that may be further added to the resin composition include a stabilizer, an ultraviolet ray absorbing agent, a lubricant, a pigment, a flame retardant, an antioxidant, a plasticizing agent, or the like.

In order to increase the compatibility of the resin component, the stability of the resin composition, and workability of the resin composition when being used, a leveling agent, a non-reactive diluent, a reactive diluent, a thixotropic agent, a thickening agent, or the like may be added to the resin composition as appropriate.

If necessary, a coupling agent may be added to the resin composition.

The coupling agent includes a silane coupling agent, a titanate coupling agent, an aluminium coupling agent, or the like. Among these, a silane coupling agent is preferably. The silane coupling agent includes a silane compound including an amino group, a silane compound including a mercapto group, a silane compound including an isocyanate group, a silane compound including an acid anhydride group, a silane compound including an isocyanuric acid group, or the like. The silane coupling agent is preferably at least one type select the group consisting of silane compounds including an amino group, silane compounds including a mercapto group, silane compounds including an isocyanate group, silane compounds including an acid anhydride group, and silane compounds including an isocyanuric acid group.

A polymer resin may be added to the resin composition. The polymer resin includes a phenoxy resin, a polysulfone resin, a poly phenylene ether resin, or the like.

(Resin Composition)

There is no particular limitation in the method for producing the resin composition. The method for producing the resin composition includes, for example, a method of adding, to a solvent, the epoxy resin, the curing agent, the curing accelerator, the surface treated substance, and if necessary, other components to be blended, and then drying and removing the solvent.

The resin composition can be suitably used as, for example, a substrate material for forming a core layer, a build-up layer, or the like of a multilayer substrate, an adhesion sheet, a laminated plate, a resin-coated copper foil, a copper clad laminated plate, a TAB tape, a printed-circuit substrate, a prepreg, a varnish, or the like.

By using the resin composition described above, fine holes can be formed on the surface of the cured body obtained by performing a roughening treatment. Therefore, fine wirings can be formed on the surface of the cured body, and the signal transmission speed of the wirings can be increased. Thus, the resin composition can be suitable for usages requiring insulation characteristics, such as a resin-coated copper foil, a copper clad laminated plate, a printed-circuit substrate, a prepreg, an adhesion sheet, or a TAB tape.

The resin composition is suitably used in build-up substrates or the like in which cured bodies and conductive plating layers are layered by using the additive process and the semi-additive process to form circuits after forming a conductive plating layer on the surface of the cured body. In such a case, joining reliability of the conductive plating layers and the cured bodies can be increased. Furthermore, since the holes that are formed as a result of the surface treated substance being eliminated from the surface of the roughening-treated cured body are small, insulation reliability between patterns can be increased. Furthermore, since the depths of the holes obtained by eliminating the surface treated substance are shallow, insulation reliability between layers and between wirings can be increased. Therefore, highly reliable fine wirings can be formed.

The resin composition can also be used as a sealing material, a solder resist, or the like. Furthermore, since high-speed signal transmission performance of the wirings formed on the surface of the cured body can be enhanced, the resin composition can also be used for a parts built-in substrate having built-in passive parts or active parts requiring high frequency characteristics.

The resin composition may be impregnated to a porous base material to be used as a prepreg.

There is no particular limitation in the porous base material as long as it can be impregnated with the resin composition. The porous base material includes an organic fiber, a glass fiber, or the like. The organic fiber includes a carbon fiber, a polyamide fiber, a polyaramid fiber, a polyester fiber, or the like. Furthermore, the form of the porous base material includes textile forms such as textiles of plain weave fabrics or twill fabrics, forms such as nonwoven fabrics, or the like. The porous base material is preferably a glass fiber nonwoven fabric.

(Resin Film and Lamination Film)

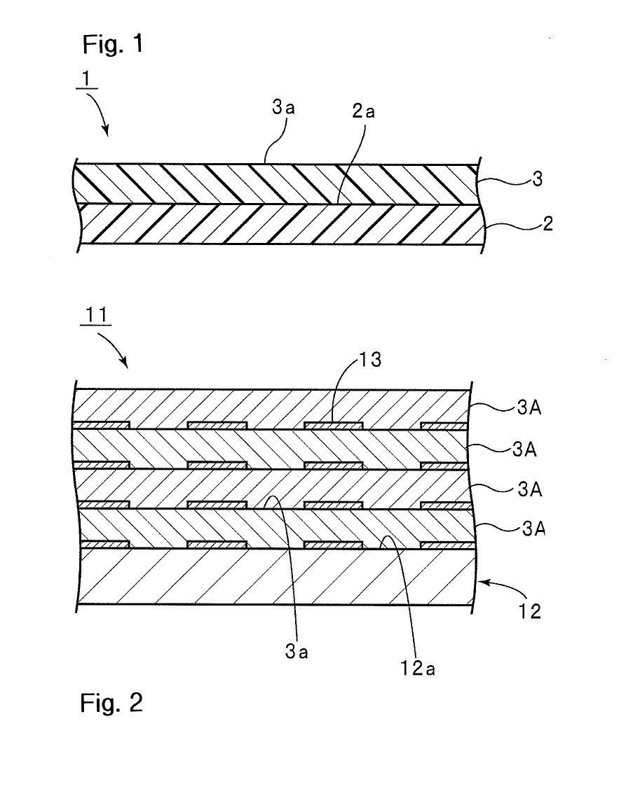

Shown in FIG. 1 is a partially-cut front sectional view of a lamination film used for obtaining a laminated body according to one embodiment of the present invention.

As shown in FIG. 1, a lamination film 1 includes a base material film 2, and a resin film 3 laminated on an upper surface 2a of the base material film 2. The resin film 3 is formed from the resin composition described above.

The base material film 2 includes a resin coated paper, a polyester film, a polyethylene terephthalate (PET) film, a polypropylene (PP) film, a metallic foil such as a copper foil, or the like.

When the resin film 3 is laminated on a substrate, separated from the base material film 2, and then when the resin film 3 is cured, it is preferable if the coefficient of elasticity of the base material film 2 is high, since the flatness of the surface of the cured body can be increased. A base material that has a high coefficient of elasticity includes a copper foil or the like.

The upper surface 2a of the base material film 2 is in contact with the lower surface of the resin film 3. Therefore, the surface roughness of the upper surface 2a of the base material film 2 influences the surface roughness of the surface of the roughening-treated cured body. Thus, it is preferable if the surface roughness of the upper surface 2a of the base material film 2 is small. Therefore, a plastic film such as a PET film is suitably used as the base material film 2. In addition, a copper foil having a relatively small surface roughness is also suitably used as the base material film 2.

In order to increase releasability, release processing may be conducted on the base material film 2. The method for release processing the base material film 2 includes a method of including a silicon compound, a fluorine compound, a surfactant, or the like in the base material, a method of providing concavities and convexities on the surface of the base material, a method of applying, on the surface of the base material, a substance having releasability such as a silicon compound, a fluorine compound, or a surfactant. The method of providing concavities and convexities on the surface of the base material includes a method of embossing the surface of the base material, or the like.

Additives such as a stabilizer, an ultraviolet ray absorbing agent, a lubricant, a pigment, an antioxidant, a leveling agent, a plasticizing agent, or the like may be added to the base material film 2.

There is no particular limitation in the thickness of the base material film 2. The thickness of the base material film 2 is preferably within a range from 10 to 200 μm. If the thickness of the base material film 2 is small, the base material film 2 is easily elongated by tensile force, and thereby wrinkles are easily generated and a dimensional change of the resin film 3 is easily caused. Therefore, the thickness of the base material film 2 is preferably equal to or larger than 20 μm.

The resin film 3 preferably does not include a solvent, or includes a solvent at a contained amount equal to or smaller than 5 wt %. If the contained amount of the solvent is larger than 5 wt %, the adhesive strength between the base material film 2 and the resin film 3 becomes strong, and it may become difficult to peel the resin film 3 off from the base material film 2. The smaller the contained amount of the solvent is, the flatness of the resin film 3 after lamination becomes easier to obtain. However, if the contained amount of the solvent is small, the resin film becomes hard, and there is a possibility that the handling performance of the resin film will deteriorate. The resin film 3 preferably includes the solvent within a range from 0.1 to 3 wt %. Note that, since one part or all the solvent is removed by drying the resin composition that includes the solvent, the resin film 3 that does not include the solvent, or includes the solvent at a contained amount equal to or smaller than 5 wt % is obtained.

The thickness of the resin film 3 is preferably within a range from 10 to 200 μm. If the thickness of the resin film 3 is within the range described above, the resin film 3 can be suitably used for forming an insulation layer of a printed wiring board or the like.

The lamination film 1 can be produced, for example, as described in the following.

The resin composition described above is applied on the upper surface 2a of the base material film 2. Next, depending on the need, the resin composition applied on the upper surface 2a of the base material film 2 is dried at around 80° C. to 150° C., and one part or all the solvent is removed. With this, the resin film 3 can be formed on the upper surface 2a of the base material film 2. The drying temperature is around 100° C. The drying time is around 30 seconds to 10 minutes. Curing of the resin composition proceeds by this drying process, and the resin film 3 may enter a semi-cured state.

Furthermore, a resin film that does not have a base material may be formed by using the resin composition.

Other methods for producing the resin film 3 include an extrusion method, a conventionally well-known film molding method other than an extrusion method, or the like.

In the extrusion method described above, the resin film can be obtained by fusing and kneading, in an extruder, the epoxy resin, the curing agent, the curing accelerator, the surface treated substance, and materials blended if necessary, extruding the resulting kneaded substance, and forming it in a film by using a T die, a circular die, or the like.

(Cured Body and Laminated Body)

The lamination film 1 can be used to form, for example, an insulation layer of a monolayer or a multilayer printed wiring board and the like.

Schematically shown in FIG. 2 is a front sectional view of a multilayer printed wiring board in which a laminated body according to one embodiment of the present invention is applied.

In a multilayer printed wiring board 11 shown in FIG. 2, a plurality of cured body layers 3A are laminated on an upper surface 12a of a substrate 12. The cured body layers 3A are insulation layers. As described later, the cured body layers 3A are formed by heating and preliminary-curing the resin film 3 to obtain a preliminary-cured body layer, and then performing a roughening treatment on the obtained preliminary-cured body layer.

A metal layer 13 is formed on one part of an area of an upper surface 3a of each of the cured body layers 3A, except for the topmost layer of the cured body layers 3A. The metal layer 13 is interposed in each interlayer of the cured body layers 3A. A lower metal layer 13 and an upper metal layer 13 are connected by at least one of a via hole connection and a through hole connection, which are not shown.

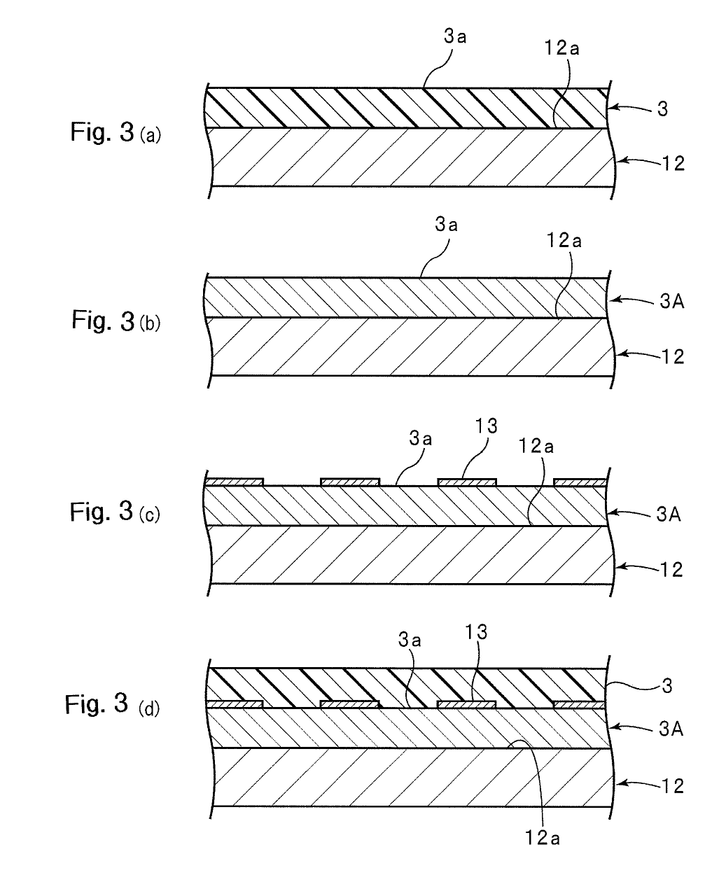

When producing the printed wiring multilayer substrate 11, first, as shown in FIG. 3(a), the resin film 3 is laminated so as to face toward the upper surface 12a of the substrate 12. In addition, the resin film 3 laminated on the upper surface 12a of the substrate 12 is pressed.

There is no particular limitation in a laminator or press machine used for the above described lamination. The laminator or press machine includes a vacuum pressurization type laminator manufactured by Meiki Co., Ltd., a vacuum press machine manufactured by Kitagawa Seiki Co., Ltd., a quick type vacuum press machine manufactured by Mikado Technos Co., Ltd., or the like.

The temperature for the lamination is preferably within a range from 70° C. to 130° C. If the temperature is too low, adherence between the resin film 3 and the upper surface 12a of the substrate 12 deteriorates, and delamination can easily occur. Furthermore, if the temperature is too low, the flatness of the upper surface 3a of the resin film 3 reduces and embedding of the resin film becomes insufficient, and thereby voids can be generated between patterns. If the temperature is too high, the thickness of the resin film 3 can be reduced, and the flatness of the upper surface 3a of the resin film 3 can be reduced. Furthermore, if the temperature is too high, the curing reaction of the resin film 3 easily proceeds. Therefore, when there are concavities and convexities on the surface of the substrate or the like having the resin film 3 laminated thereon, the filling performance of the resin film 3 to the concavities and convexities may deteriorate. With regard to the temperature for the lamination, a preferable lower limit is 80° C., a preferable upper limit is 120° C., and a more preferable upper limit is 100° C.

The pressure applied for the lamination a preferably within a range from 0.1 to 2.0 MPa. If the pressure applied for the lamination is too low, adherence between the resin film 3 and the upper surface 12a of the substrate 12 deteriorates, and delamination can easily occur. Furthermore, if the pressure is too low, the upper surface 3a of the resin film 3 cannot be made sufficiently flat, and when there are concavities and convexities on the surface on which the resin film 3 is laminated, the filling performance of the resin film 3 to the concavities and convexities may deteriorate. If the pressure is too high, film loss can occur for the resin film. Furthermore, if the pressure is too high, when there are concavities and convexities on the surface on which the resin film 3 is laminated, the pressure applied to the resin film 3 tends to be largely different from part to part due to having the concavities and convexities. Therefore, unevenness in the thickness of the resin film 3 can occur easily, and there are cases where the upper surface 3a of the resin film 3 cannot be made sufficiently flat. With regard to the pressure described above, a preferable lower limit is 0.3 MPa, a preferable upper limit is 1.0 MPa, and a more preferable upper limit is 0.8 MPa.

There is no particular limitation in the time used for the pressing described above. The pressing time described above is preferably within a range from 6 seconds to 6 hours, since this allows increasing the working efficiency. Furthermore, when there are concavities and convexities of the surface on which the resin film 3 is laminated, the concavities and convexities can be sufficiently filled with the resin film 3, and flatness of the upper surface 3a of the resin film 3 can be ensured.

After the resin film 3 is laminated on the upper surface 12a of the substrate 12, a curing step (heating step) is performed.

In the curing step, the resin film 3 is heated and preliminary-cured. An oven or the like is used for the heating. When the resin film 3 is heated, the resin film 3 on the upper surface 12a of the substrate 12 is cured to form a preliminary-cured body layer.

The heating temperature at the curing step is within a range from 100° C. to 200° C. If the heating temperature is too low, the resin film 3 may not sufficiently be cured. Furthermore, if the heating temperature is too low, the surface roughness of the surface of the roughening-treated cured body may become large, and the adhesive strength between the cured body layer and the metal layer may deteriorate. If the heating temperature is too high, the resin film 3 can easily undergo thermal contraction. Therefore, the flatness of an upper surface of the preliminary-cured body layer may not be sufficiently ensured. In addition, if the heating temperature is too high, the curing reaction of the resin composition tends to proceed rapidly. Therefore, the degree of curing tends to differ locally, and rough portions and dense portions tend to be formed. As a result, the surface roughness of the surface of the roughening-treated cured body tends to be large. A preferable lower limit of the heating temperature is 130° C., and a preferable upper limit is 200° C. If the heating temperature is too high, performing a later described roughening treatment may become difficult.

The heating time at the curing step is preferably within a range from 3 to 120 minutes. If the heating time is too short, the resin film 3 may not sufficiently be cured. If the heating time is too long, performing a later described roughening treatment may become difficult.

When performing the heating described above, a stepwise curing method or the like in which the temperature is increased gradually may be used.

After the curing step, a swelling treatment and a roughening treatment are performed on the surface of the preliminary-cured body layer. Alternatively, only the roughening treatment but not the swelling treatment may be performed on the preliminary-cured body layer. Even so, it is preferable to perform the roughening treatment after performing the swelling treatment on the preliminary-cured body layer.

There is no particular limitation in the method for performing the swelling treatment on the preliminary-cured body layer. The swelling treatment is performed by using a conventionally well-known method, and examples thereof include a method of processing the preliminary-cured body layer by using an aqueous solution or organic solvent dispersed liquid including, as a main component, ethylene glycol, dimethylformamide, dimethyl sulfoxide, N-methyl-2-pyrrolidone, pyridine, sulfuric acid, sulfonic acid, or the like. Among these, a method of processing the preliminary-cured body layer in an aqueous solution including ethylene glycol is preferably. The temperature for the swelling treatment is preferably within a range from 50° C. to 80° C. A more preferable lower limit of the swelling temperature is 60° C. If the temperature for the swelling treatment is too low, after the roughening treatment, the adhesive strength between the cured body layer and the metal layer may deteriorate. If the temperature for the swelling treatment is too high, the surface roughness of the surface of the roughening-treated cured body tends to be large.

The time used for the swelling treatment is preferably from 1 to 40 minutes, more preferably from 5 to 30 minutes, and further preferably from 5 to 20 minutes. If the time used for the swelling treatment is too short, the adhesive strength between the roughening-treated cured body layer and the metal layer may deteriorate. If the time used for the swelling treatment is too long, the surface roughness of the surface of the roughening-treated cured body tends to be large.

There is no particular limitation in the method for performing the roughening treatment on the preliminary-cured body layer. The roughening treatment is performed by using a conventionally well-known method, and examples thereof include a method of processing the preliminary-cured body layer by using a roughening treatment liquid such as an aqueous solution or organic solvent dispersed liquid of a chemical oxidant including, as a main component, a manganese compound, a chromium compound, a persulfuric acid compound, or the like.

The manganese compound includes potassium permanganate, sodium permanganate, or the like. The chromium compound includes potassium dichromate, potassium chromate anhydride, or the like. The persulfuric acid compound includes sodium persulfate, potassium persulfate, ammonium persulfate, or the like.

The temperature for the roughening treatment is within a range from 55° C. to 80° C. A preferable lower limit of the temperature for the roughening treatment is 60° C. If the temperature for the roughening treatment is too low, the adhesive strength between the roughening-treated cured body layer and the metal layer may deteriorate. If the temperature for the roughening treatment is too high, the surface roughness of the surface of the roughening-treated cured body may become large, and the adhesive strength between the cured body layer and the metal layer may deteriorate.

The time used for the roughening treatment is preferably from 1 to 30 minutes, and more preferably from 5 to 30 minutes. If the time used for the roughening treatment is too short, the adhesive strength between the roughening-treated cured body layer and the metal layer may deteriorate. If the time used for the roughening treatment is too long, the surface roughness of the surface of the roughening-treated cured body tends to be large. Furthermore, the adhesive strength between the cured body layer and the metal layer tends to deteriorate.

The roughening treatment may be performed only once, or may be performed for multiple times. If the number of the roughening treatment performed is large, a roughening effect is also large. However, if the number of the roughening treatment performed is larger than three, the roughening effect may saturate, or the resin component on the surface of the cured body is removed more than necessary and thereby a hole having a shape obtained by an elimination of the surface treated substance may become difficult to be formed on the surface of the cured body layer.

Those that can be suitably used as the roughening treatment liquid include a permanganic acid solution having a concentration from 30 to 90 g/L, a permanganate solution having a concentration from 30 to 90 g/L, or a sodium hydroxide solution having a concentration from 30 to 90 g/L. The preliminary-cured body layer is preferably immersed and oscillated in any one of these roughening treatment liquids.

As described above, a roughening-treated cured body layer 3A can be formed on the upper surface 12a of the substrate 12 as shown in FIG. 3(b).

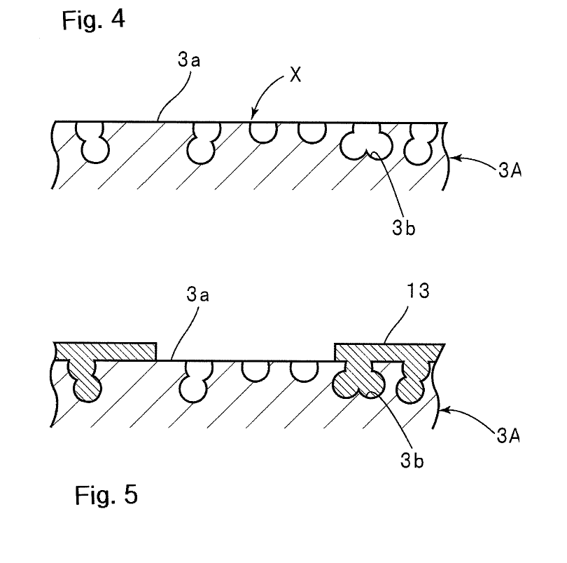

FIG. 4 shows a cured body layer 3A in FIG. 3 (b) in an enlarged manner. A plurality of holes 3b, which are formed by the elimination of the surface treated substance described above, are formed on the upper surface 3a of the roughening-treated cured body layer 3A as shown in FIG. 4.

The resin composition includes the surface treated substance obtained by performing a surface treatment on the silane coupling agent using the above described specific amount of the inorganic filler. Therefore, the dispersibility of the surface treated substance in the resin composition is excellent. Thus, large holes resulting from an elimination of an aggregate of the surface treated substance are hardly formed on the upper surface 3a of the cured body layer 3A. Therefore, the strength of the cured body layer 3A hardly deteriorates locally, and the adhesive strength between the cured body layer 3A and the metal layer can be increased. Furthermore, a higher amount of the surface treated substance may be blended in the resin composition in order to reduce the linear expansion coefficient of the cured body layer 3A. Even if the surface treated substance is blended in a higher amount, the plurality of fine holes 3b can be formed on the surface of the cured body layer 3A. Each of the holes 3b may be a hole resulting from an elimination of a lump including couple of pieces, for example, two to ten pieces of the surface treated substance.

The resin component, which is at a portion shown in FIG. 4 with arrow X and which is in proximity of the holes 3b formed resulting from the elimination of the surface treated substance, hardly gets removed at a degree more than necessary. Therefore, the strength of the cured body layer 3A can be increased.

The surface of the roughening-treated cured body layer 3A (cured body) obtained as described above preferably has an arithmetic mean roughness Ra equal to or less than 300 nm, and a ten-point mean roughness Rz equal to or less than 3.0 μm. The arithmetic mean roughness Ra of the surface of the cured body layer 3A is more preferably equal to or less than 200 nm, and further preferably equal to or less than 150 nm. The ten-point mean roughness Rz of the surface of the cured body layer 3A is more preferably equal to or less than 2 μm, and further preferably equal to or less than 1.5 μm. If the arithmetic mean roughness Ra is too large, or if the ten-point mean roughness Rz is too large, an increase in the transmission speed of electric signals through metal wirings formed on the surface of the cured body layer 3A may not be achieved. The arithmetic mean roughness Ra and the ten-point mean roughness Rz can be obtained using measuring methods conforming to JIS B0601-1994.

After performing the roughening treatment, the metal layer 13 is formed on the upper surface 3a of the roughening-treated cured body layer 3A as shown in FIG. 3(c). There is no particular limitation in the method for forming the metal layer 13. The metal layer 13 can be formed by performing a nonelectrolytic plating on the upper surface 3a of the cured body layer 3A, or further performing an electrolysis plating after performing the nonelectrolytic plating. Fine concavities and convexities may be formed on the upper surface 3a, by conducting a plasma treatment or a chemical treatment on the upper surface 3a of the cured body layer 3A before performing the nonelectrolytic plating.

The plating material includes, for example, gold, silver, copper, rhodium, palladium, nickel, tin, or the like. An alloy of two or more of these types may be used. The metal layer may be formed from multiple layers using two or more types of plating materials.

The adhesive strength (post-roughened adhesive strength) between the cured body layer 3A and the metal layer 13 is preferably equal to or higher than 4.9 N/cm.

The cured body layer 3A, in which the metal layer 13 shown in FIG. 3(c) is formed on the upper surface 3a, is enlarged in FIG. 5. In FIG. 5, the metal layer 13 extends into the fine holes 3b formed on the upper surface 3a of the roughening-treated cured body layer 3A. As a result, due to a physical anchoring effect, the adhesive strength between the cured body layer 3A and the metal layer 13 can be increased. In addition, since the resin component in proximity of the holes 3b formed resulting from the elimination of the surface treated substance is not removed at a degree more than necessary, the adhesive strength between the cured body layer 3A and the metal layer 13 can be increased.

If the mean particle diameter of the inorganic filler is smaller, finer concavities and convexities can be formed on the surface of the cured body layer 3A. Since the used surface treated substance is obtained by performing a surface treatment using the silane coupling agent on the inorganic filler with a mean particle diameter equal to or less than 1.5 μm, the holes 3b can be made small, and therefore, fine concavities and convexities can be formed on the surface of the cured body layer 3A. Therefore, L/S, which indicates the degree of fineness of circuit wirings, can be reduced.

As shown in FIG. 3(d), the multilayer printed wiring board 11 shown in FIG. 2 can be obtained by laminating another resin film 3 on the upper surface 3a of the cured body layer 3A in which the metal layer 13 is formed on the upper surface 3a, and repeatedly conducting each of the steps described above.

The present invention will be described specifically in the following by showing examples and comparative examples. The present invention is not limited to the following examples.

In the examples and comparative examples, materials shown in the following were used.

[Epoxy Resin]

Bisphenol A type epoxy resin (1) (product name “Epicoat 828”; epoxy equivalent of 189; viscosity of 12 to 15 Pa·s at 25° C.; manufactured by JER Co., Ltd.)

[Curing Agent]

Biphenyl type phenol curing agent (1) (product name “MEH7851-4H”; OH equivalent of 243; softening point of 130° C.; Manufactured by Meiwa Plastic Industries, Ltd.)

Naphthol curing agent (2) (product name “SN485”; OH equivalent of 213; softening point of 86° C.; manufactured by Tohto Kasei Co., Ltd.)

Active ester curing agent (active ester compound; manufactured by DIC Corp.; product name “EPICLON EXB9460S-65T”; toluene solution having solid content of 65%)

[Curing Accelerator]

Accelerator (1) (product name “2PZ-CN”; 1-cyanoethyl-2-phenylimidazole; manufactured by Shikoku Chemicals Corp.)

[Surface Treated Substance]

50 wt % silica DMF dispersion liquid (1): A dispersion liquid that includes 50 wt % of DMF (N,N-dimethylformamide) and 50 wt % of a surface treated substance obtained by performing a surface treatment on 100 parts by weight of a silica particle having a mean particle diameter of 0.3 μm and a specific surface area of 18 m²/g, by using 1.0 parts by weight of an amino silane coupling agent (product name “KBE-903”; manufactured by Shin-Etsu Chemical Co., Ltd.).

50 wt % silica DMF dispersion liquid (2): A dispersion liquid that includes 50 wt % of DMF and 50 wt % of a surface treated substance obtained by performing a surface treatment on 100 parts by weight of a silica particle having a mean particle diameter of 0.3 μm and a specific surface area of 18 m²/g, by using 2.5 parts by weight of an amino silane coupling agent (product name “KBE-903”; manufactured by Shin-Etsu Chemical Co., Ltd.).

50 wt % silica DMF dispersion liquid (3): A dispersion liquid that includes 50 wt % of DMF and 50 wt % of a surface treated substance obtained by performing a surface treatment on 100 parts by weight of a silica particle having a mean particle diameter of 1.5 μm and a specific surface area of 3 m²/g, by using 1.0 parts by weight of an amino silane coupling agent (product name “KBE-903”; manufactured by Shin-Etsu Chemical Co., Ltd.).

50 wt % silica DMF dispersion liquid (4): A dispersion liquid that includes 50 wt % of DMF and 50 wt % of a surface treated substance obtained by performing a surface treatment on 100 parts by weight of a silica particle having a mean particle diameter of 0.3 μm and a specific surface area of 18 m²/g, by using 1.0 parts by weight of an epoxy silane coupling agent (product name “KBE-403”; manufactured by Shin-Etsu Chemical Co., Ltd.).

50 wt % silica DMF dispersion liquid (5): A dispersion liquid that includes 50 wt % of DMF and 50 wt % of a surface treated substance obtained by performing a surface treatment on 100 parts by weight of a silica particle having a mean particle diameter of 0.3 μm and a specific surface area of 18 m²/g, by using 1.0 parts by weight of an imidazole silane coupling agent (product name “IM-1000”; manufactured by Nippon Mining & Metals Co., Ltd.).

50 wt % silica DMF dispersion liquid (6): A dispersion liquid that includes 50 wt % of DMF and 50 wt % of a surface treated substance obtained by performing a surface treatment on 100 parts by weight of a silica particle having a mean particle diameter of 0.3 μm and a specific surface area of 18 m²/g, by using 4.0 parts by weight of an amino silane coupling agent (product name “KBE-903”; manufactured by Shin-Etsu Chemical Co., Ltd.).

50 wt % silica DMF dispersion liquid (7): A dispersion liquid that includes 50 wt % of DMF and 50 wt % of a surface treated substance obtained by performing a surface treatment on 100 parts by weight of a silica particle having a mean particle diameter of 0.01 μm and a specific surface area of 150 m²/g, by using 1.0 parts by weight of an amino silane coupling agent (product name “KBE-903”; manufactured by Shin-Etsu Chemical Co., Ltd.).

50 wt % silica DMF dispersion liquid (8): A dispersion liquid that includes 50 wt % of DMF and 50 wt % of a surface treated substance obtained by performing a surface treatment on 100 parts by weight of an silica particle having a mean particle diameter of 4.5 μm and a specific surface area of 2 m²/g, by using 1.0 parts by weight of an amino silane coupling agent (product name “KBE-903”; manufactured by Shin-Etsu Chemical Co., Ltd.).

[Solvent]

DMF: N,N-dimethylformamide (special grade reagent; manufactured by Wako Pure Chemical Industries, Ltd.)

(Imidazole Silane Compound)

Imidazole silane (manufactured by Nippon Mining & Metals Co., Ltd.; product name “IM-1000”)

### Example 1

### (1) Preparation of Resin Composition

19.71 g of the bisphenol A type epoxy resin (1), 0.45 g of the accelerator (1), and 39.00 g of the 50 wt % silica DMF dispersion liquid (1) were added in 15.50 g of N,N-dimethylformamide, mixed thoroughly, and agitated at an ordinary temperature until a homogeneous solution was obtained.

Next, a resin composition was prepared by further adding, to the above, 25.34 g of the biphenyl type phenol curing agent (1), and agitating at an ordinary temperature until a homogeneous solution was obtained.

### (2) Preparation of Lamination Film

The obtained resin composition was applied on a release-processed PET film by using an applicator such that a thickness after drying was 40 μm. Next, it was dried for 1 minute in a gear oven at 100° C., and a resin film in a semi-cured B stage state was formed on the PET film. In the manner described above, a lamination film in which the resin film is laminated on the PET film was prepared.

### (3) Preparation of Printed Wiring Board

A printed wiring board was prepared by using the obtain lamination film in the following manner.

A substrate having a 75 μm interval copper pattern (a single copper pattern: length 40 μm×width 40 μm×thickness 1 cm) formed on the upper surface thereof was prepared. By using a parallel plate type vacuum pressurization type laminator (Meiki Co., Ltd.), the lamination film was placed on the substrate such that the B stage state resin film was on the substrate side, and heated and pressurized for 1 minute at a condition of 100° C. lamination temperature and 0.6 MPa lamination pressure to form a laminate. Then, the PET film was separated and removed.

The substrate, on which the B stage state resin film has been laminated, was placed inside a gear oven such that the principal surface of the substrate was positioned in a plane that is parallel to the vertical direction. Then, the substrate was heated for one hour at a curing temperature of 150° C., and the B stage state resin film was cured and a preliminary-cured body layer was form on the substrate to obtain a lamination sample.

Next, on the preliminary-cured body layer which is the lamination sample, (a) swelling treatment described in the following was performed, (b) permanganate treatment which is described in the following and which is a roughening treatment was performed to form a cured body layer, and (c) copper plate processing described in the following was further performed on the cured body layer.

(a) Swelling Treatment:

The lamination sample described above was placed in a 70° C. swelling liquid (Swelling Dip Securigant P; manufactured by Atotech Japan Co., Ltd.), oscillated for 15 minutes at a swelling temperature of 70° C., and rinsed in pure water.

(b) Permanganate Treatment:

The lamination sample described above was placed in a 70° C. potassium permanganate (Concentrate Compact CP; manufactured by Atotech Japan Co., Ltd.) roughening solution, and oscillated for 15 minutes at a roughening temperature of 70° C. to form a roughening-treated cured body layer on the substrate. The obtained cured body layer was rinsed for 2 minutes by using a 25° C. rinsing liquid (Reduction Securigant P; manufactured by Atotech Japan Co., Ltd.), and further rinsed in pure.

(c) Copper Plate Processing:

Next, by using the procedures described in the following, an electroless copper plating and an electrolytic copper plating were conducted on the cured body layer on which the substrate was formed.

The surface of the cured body layer described above was delipidated and rinsed by being treated with a 60° C. alkaline cleaner (Cleaner Securigant 902) for 5 minutes. After the rinsing, the cured body layer was treated a 25° C. predip liquid (Pre-dip Neogant B) for 2 minutes. Then, the cured body layer was treated with a 40° C. activator liquid (Activator Neogant 834) for 5 minutes in order to be provided with a palladium catalyst. Next, the cured body was treated for 5 minutes by using a 30° C. reduction liquid (Reducer Neogant WA).

Next, the cured body layer was placed in a chemically copper enriched liquid (Basic Printgant MSK-DK; Copper Printgant MSK; Stabilizer Printgant MSK) to apply a nonelectrolytic plating until the plating thickness was approximately 0.5 μm. After the nonelectrolytic plating, annealing was conducted for 30 minutes at a temperature of 120° C. in order to remove any residual hydrogen gas. All the processes up to the process of nonelectrolytic plating were conducted at a beaker scale with 1 L of processing liquids by oscillating the cured bodies.

Next, electrolysis plating was applied to the nonelectrolytic plating-processed cured body layer until the plating thickness was 20 μm. Copper sulfate (Reducer Cu) was used for the electrolytic copper plating, and an electric current of 0.6 A/cm² was passed therethrough. After the copper plate processing, the cured body layer was heated and cured for 1 hour at 180° C. to obtain a cured body layer having a copper plating layer formed thereon. As a result, a printed wiring board as a laminated body was obtained.

### Example 2 to 9, Examples 16 and 17, and Comparative Examples 5 to 8

Printed wiring boards were prepared similarly to Example 1 by using the lamination film obtained in Example 1, except for changing the lamination temperature, the lamination pressure, the curing temperature, the swelling temperature, or the roughening temperature as shown in the following Tables 1, 2, and 4.

### Examples 10 to 15, Examples 18 to 24, and Comparative Examples 1 to 4

Resin compositions were prepared similarly to Example 1, except for using materials at blend amounts shown in Tables 2 to 4. Except for using the obtained resin compositions, lamination films were prepared and printed wiring boards were prepared similarly to Example 1. Note that, if a resin composition was to include an imidazole silane, the imidazole silane was added together with a curing agent.

(Evaluation)

(1) Post-Roughened Adhesive Strength

A 10-mm width notch was made on the surface of the copper plating layer of the cured body layer formed on the copper plating layer. Then, the adhesive strength between the copper plating layer and the cured body layer was measured using a tensile testing machine (product name “Autograph”; manufactured by Shimadzu Corp) with a condition of a crosshead speed of 5 mm/minute, and the obtained measured value was used as a post-roughened adhesive strength.

(2) Arithmetic Mean Roughness Ra and Ten-Point Mean Roughness Rz

A roughening-treated cured body layer, prior to having plating layers formed thereon, was prepared when obtaining the cured body layer having the plating layer formed thereon. The arithmetic mean roughness Ra and the ten-point mean roughness Rz of the surface of the roughening-treated cured body were measured using a non-contact three-dimensional surface profile measuring apparatus (stock number “WYKO NT1100”; manufactured by Veeco Instruments Inc.) in a 100 μm² measurement area.

The results are shown in the following Tables 1 to 4.

TABLE 1

| | | | Exam- | Exam- | Exam- | Exam- | Exam- | Exam- | Exam- | Exam- | Exam- |
|---|---|---|---|---|---|---|---|---|---|---|---|
| | | | ple 1 | ple 2 | ple 3 | ple 4 | ple 5 | ple 6 | ple 7 | ple 8 | ple 9 |
| Blend | Epoxy | Bisphenol A Type Epoxy Resin (1) | 19.71 | 19.71 | 19.71 | 19.71 | 19.71 | 19.71 | 19.71 | 19.71 | 19.71 |
| Compo- | Resin | | | | | | | | | | |
| nent | Curing | Biphenyl Type Phenol Curing Agent (1) | 25.34 | 25.34 | 25.34 | 25.34 | 25.34 | 25.34 | 25.34 | 25.34 | 25.34 |
| (Parts | Agent | Naphthol Curing Agent | | | | | | | | | |
| by | Curing | Accelerator (1) | 0.45 | 0.45 | 0.45 | 0.45 | 0.45 | 0.45 | 0.45 | 0.45 | 0.45 |
| Weight) | Accel- | | | | | | | | | | |
| | erator | | | | | | | | | | |
| | Silica | 50 wt % Silica DMF Dispersion Liquid (1) | 39.00 | 39.00 | 39.00 | 39.00 | 39.00 | 39.00 | 39.00 | 39.00 | 39.00 |
| | Slurry | 50 wt % Silica DMF Dispersion Liquid (2) | | | | | | | | | |
| | | 50 wt % Silica DMF Dispersion Liquid (3) | | | | | | | | | |
| | | 50 wt % Silica DMF Dispersion Liquid (4) | | | | | | | | | |
| | | 50 wt % Silica DMF Dispersion Liquid (5) | | | | | | | | | |
| | | 50 wt % Silica DMF Dispersion Liquid (6) | | | | | | | | | |
| | | 50 wt % Silica DMF Dispersion Liquid (7) | | | | | | | | | |
| | | 50 wt % Silica DMF Dispersion Liquid (8) | | | | | | | | | |
| | Solvent | DMF | 15.50 | 15.50 | 15.50 | 15.50 | 15.50 | 15.50 | 15.50 | 15.50 | 15.50 |
| Contained Amount of Surface Treated Substance (wt %) [symbol] 1 | | | 30 | 30 | 30 | 30 | 30 | 30 | 30 | 30 | 30 |
| Proc- | Lamination Temperature (° C.) | | 100 | 70 | 120 | 100 | 100 | 100 | 100 | 100 | 100 |
| essing | Lamination Pressure (MPa) | | 0.6 | 0.6 | 0.6 | 0.3 | 0.8 | 0.6 | 0.6 | 0.6 | 0.6 |
| Condi- | Curing Temperature (° C.) | | 150 | 150 | 150 | 150 | 150 | 120 | 180 | 150 | 150 |
| tions | Swelling Temperature (° C.) | | 70 | 70 | 70 | 70 | 70 | 70 | 70 | 80 | 70 |
| | Roughening Temperature (° C.) | | 70 | 70 | 70 | 70 | 70 | 70 | 70 | 70 | 80 |
| Eval- | Surface | Arithmetic Mean Roughness Ra (nm) | 100 | 105 | 97 | 98 | 110 | 150 | 70 | 170 | 168 |
| uation | Roughness | Ten-Point Mean Roughness Rz (μm) | 1.00 | 1.00 | 1.10 | 0.93 | 1.12 | 1.80 | 0.63 | 1.70 | 1.59 |

| | | | | | | | | | |
|---|---|---|---|---|---|---|---|---|---|
| Post-Roughened Adhesive Strength (N/cm) | 5.9 | 5.8 | 6.2 | 5.4 | 5.8 | 6.9 | 5.1 | 6.7 | 6.8 |

[symbol]

1 Contained Amount of Surface Treated Substance in a total 100 wt % of Epoxy Resin, Curing Agent, Curing Accelerator, and Surface Treated Substance

TABLE 2

| | | | Exam- | Exam- | Exam- | Exam- | Exam- | Exam- | Exam- | Example |
|---|---|---|---|---|---|---|---|---|---|---|
| | | | ple 10 | ple 11 | ple 12 | ple 13 | ple 14 | ple 15 | ple 16 | 17 |
| Blend | Epoxy Resin | Bisphenol A Type Epoxy Resin (1) | 19.71 | 19.71 | 19.71 | 19.71 | 15.49 | 21.18 | 19.71 | 19.71 |
| Component | Curing | Biphenyl Type Phenol Curing Agent (1) | 25.34 | 25.34 | 25.34 | 25.34 | 19.91 | | 25.34 | 25.34 |
| (Parts by | Agent | Naphthol Curing Agent | | | | | | 23.87 | | |
| Weight) | Curing | Accelerator (1) | 0.45 | 0.45 | 0.45 | 0.45 | 0.35 | 0.45 | 0.45 | 0.45 |
| | Accelerator | | | | | | | | | |
| | Silica Slurry | 50 wt % Silica DMF Dispersion Liquid (1) | | | | | 58.50 | 39.00 | 39.00 | 39.00 |
| | | 50 wt % Silica DMF Dispersion Liquid (2) | 39.00 | | | | | | | |
| | | 50 wt % Silica DMF Dispersion Liquid (3) | | 39.00 | | | | | | |
| | | 50 wt % Silica DMF Dispersion Liquid (4) | | | 39.00 | | | | | |
| | | 50 wt % Silica DMF Dispersion Liquid (5) | | | | 39.00 | | | | |
| | | 50 wt % Silica DMF Dispersion Liquid (6) | | | | | | | | |
| | | 50 wt % Silica DMF Dispersion Liquid (7) | | | | | | | | |
| | | 50 wt % Silica DMF Dispersion Liquid (8) | | | | | | | | |
| | Solvent | DMF | 15.50 | 15.50 | 15.50 | 15.50 | 5.75 | 15.50 | 15.50 | 15.50 |
| Contained Amount of Surface Treated Substance (wt %) [symbol] 1 | | | 30 | 30 | 30 | 30 | 45 | 30 | 30 | 30 |
| Processing | Lamination Temperature (° C.) | | 100 | 100 | 100 | 100 | 100 | 100 | 100 | 100 |
| Conditions | Lamination Pressure (MPa) | | 0.6 | 0.6 | 0.6 | 0.6 | 0.6 | 0.6 | 0.6 | 0.6 |
| | Curing Temperature (° C.) | | 150 | 150 | 150 | 150 | 150 | 150 | 150 | 150 |
| | Swelling Temperature (° C.) | | 70 | 70 | 70 | 70 | 70 | 70 | 50 | 90 |
| | Roughening Temperature (° C.) | | 70 | 70 | 70 | 70 | 70 | 70 | 70 | 70 |
| Evaluation | Surface | Arithmetic Mean Roughness Ra (nm) | 125 | 180 | 118 | 92 | 200 | 130 | 60 | 298 |
| | Roughness | Ten-Point Mean Roughness Rz (μm) | 1.19 | 1.90 | 1.09 | 0.87 | 2.03 | 1.28 | 0.51 | 2.90 |

| | | | | | | | | |
|---|---|---|---|---|---|---|---|---|
| Post-Roughened Adhesive Strength (N/cm) | 6.4 | 7.2 | 6.3 | 5.2 | 7.4 | 6.4 | 3.3 | 6.0 |

[symbol]

1 Contained Amount of Surface Treated Substance in a total 100 wt % of Epoxy Resin, Curing Agent, Curing Accelerator, and Surface Treated Substance

TABLE 3

| | | | Example | Exam- | Example | Exam- | Example | Exam- | Example |
|---|---|---|---|---|---|---|---|---|---|
| | | | 18 | ple 19 | 20 | ple 21 | 22 | ple 23 | 24 |
| Blend | Epoxy Resin | Bisphenol A Type Epoxy Resin (1) | 20.41 | 19.71 | 19.71 | 19.71 | 19.71 | 19.71 | 21.18 |
| Component | Curing Agent | Biphenyl Type Phenol Curing Agent (1) | | 25.34 | 25.34 | 25.34 | 25.34 | 25.34 | |
| (Parts by | | Naphthol Curing Agent | | | | | | | 23.87 |
| Weight) | | Active Ester Curing Agent | 39.34 | | | | | | |
| | Curing | Accelerator (1) | 0.45 | 0.45 | 0.45 | 0.45 | 0.45 | 0.45 | 0.45 |
| | Accelerator | | | | | | | | |
| | Silica Slurry | 50 wt % Silica DMF Dispersion Liquid (1) | 39.70 | 39.00 | | | | | 39.00 |
| | | 50 wt % Silica DMF Dispersion Liquid (2) | | | 39.00 | | | | |
| | | 50 wt % Silica DMF Dispersion Liquid (3) | | | | 39.00 | | | |
| | | 50 wt % Silica DMF Dispersion Liquid (4) | | | | | 39.00 | | |
| | | 50 wt % Silica DMF Dispersion Liquid (5) | | | | | | 39.00 | |
| | | 50 wt % Silica DMF Dispersion Liquid (6) | | | | | | | |
| | | 50 wt % Silica DMF Dispersion Liquid (7) | | | | | | | |
| | | 50 wt % Silica DMF Dispersion Liquid (8) | | | | | | | |
| | Imidazole | Imidazole Silane | | 0.15 | 0.15 | 0.15 | 0.15 | 0.15 | 0.15 |
| | Silane | | | | | | | | |
| | Compound | | | | | | | | |
| | Solvent | DMF | | 15.50 | 15.50 | 15.50 | 15.50 | 15.50 | 15.50 |
| Contained Amount of Surface Treated Substance (wt %) [symbol] 1 | | | 30 | 30 | 30 | 30 | 30 | 30 | 30 |
| Processing | Lamination Temperature (° C.) | | 100 | 100 | 100 | 100 | 100 | 100 | 100 |
| Conditions | Lamination Pressure (MPa) | | 0.6 | 0.6 | 0.6 | 0.6 | 0.6 | 0.6 | 0.6 |
| | Curing Temperature (° C.) | | 150 | 150 | 150 | 150 | 150 | 150 | 150 |
| | Swelling Temperature (° C.) | | 70 | 70 | 70 | 70 | 70 | 70 | 70 |
| | Roughening Temperature (° C.) | | 70 | 70 | 70 | 70 | 70 | 70 | 70 |
| Evaluation | Surface | Arithmetic Mean Roughness Ra (nm) | 84 | 76 | 89 | 130 | 82 | 68 | 94 |
| | Roughness | Ten-Point Mean Roughness Rz (μm) | 0.92 | 0.86 | 0.96 | 1.42 | 0.90 | 0.72 | 1.02 |

| | | | | | | | |
|---|---|---|---|---|---|---|---|
| Post-Roughened Adhesive Strength (N/cm) | 5.6 | 7.5 | 7.8 | 8.8 | 8.0 | 7.0 | 7.9 |

[symbol]

1 Contained Amount of Surface Treated Substance in a total 100 wt % of Epoxy Resin, Curing Agent, Curing Accelerator, and Surface Treated Substance

TABLE 4

| | | | Com- | Com- | Com- | Com- | Com- | Com- | Com- | Com- |
|---|---|---|---|---|---|---|---|---|---|---|
| | | | parative | parative | parative | parative | parative | parative | parative | parative |
| | | | Exam- | Exam- | Exam- | Exam- | Exam- | Exam- | Exam- | Exam- |
| | | | ple 1 | ple 2 | ple 3 | ple 4 | ple 5 | ple 6 | ple 7 | ple 8 |
| Blend | Epoxy Resin | Bisphenol A Type Epoxy Resin (1) | 16.49 | 16.49 | 16.49 | 10.74 | 19.71 | 19.71 | 19.71 | 19.71 |
| Component | Curing Agent | Biphenyl Type Phenol Curing Agent (1) | 21.21 | 21.21 | 21.21 | 13.81 | 25.34 | 25.34 | 25.34 | 25.34 |
| (Parts by | | Naphthol Curing Agent | | | | | | | | |
| Weight) | Curing | Accelerator (1) | 0.38 | 0.38 | 0.38 | 0.25 | 0.45 | 0.45 | 0.45 | 0.45 |
| | Accelerator | | | | | | | | | |
| | Silica Slurry | 50 wt % Silica DMF Dispersion Liquid (1) | | | | 74.40 | 39.00 | 39.00 | 39.00 | 39.00 |
| | | 50 wt % Silica DMF Dispersion Liquid (2) | | | | | | | | |
| | | 50 wt % Silica DMF Dispersion Liquid (3) | | | | | | | | |
| | | 50 wt % Silica DMF Dispersion Liquid (4) | | | | | | | | |
| | | 50 wt % Silica DMF Dispersion Liquid (5) | | | | | | | | |
| | | 50 wt % Silica DMF Dispersion Liquid (6) | 32.64 | | | | | | | |
| | | 50 wt % Silica DMF Dispersion Liquid (7) | | 32.64 | | | | | | |
| | | 50 wt % Silica DMF Dispersion Liquid (8) | | | 32.64 | | | | | |
| | Solvent | DMF | 29.29 | 29.29 | 29.29 | 0.80 | 15.50 | 15.50 | 15.50 | 15.50 |
| Contained Amount of Surface Treated Substance (wt %) [symbol] 1 | | | 30 | 30 | 30 | 60 | 30 | 30 | 30 | 30 |
| Processing | Lamination Temperature (° C.) | | 100 | 100 | 100 | 100 | 100 | 100 | 100 | 100 |
| Conditions | Lamination Pressure (MPa) | | 0.6 | 0.6 | 0.6 | 0.6 | 0.6 | 0.6 | 0.6 | 0.6 |
| | Curing Temperature (° C.) | | 150 | 150 | 150 | 150 | 80 | 230 | 150 | 150 |
| | Swelling Temperature (° C.) | | 70 | 70 | 70 | 70 | 70 | 70 | 70 | 70 |
| | Roughening Temperature (° C.) | | 70 | 70 | 70 | 70 | 70 | 70 | 50 | 90 |
| Evaluation | Surface | Arithmetic Mean Roughness Ra (nm) | 290 | 60 | 383 | 420 | 350 | 50 | 46 | 310 |
| | Roughness | Ten-Point Mean Roughness Rz (μm) | 3.21 | 0.39 | 3.50 | 4.20 | 3.50 | 0.34 | 0.31 | 2.78 |

| | | | | | | | | |
|---|---|---|---|---|---|---|---|---|
| Post-Roughened Adhesive Strength (N/cm) | 6.0 | 3.1 | 6.8 | 5.7 | 3.5 | 2.3 | 3.0 | 4.2 |

[symbol]

1 Contained Amount of Surface Treated Substance in a total 100 wt % of Epoxy Resin, Curing Agent, Curing Accelerator, and Surface Treated Substance

### DESCRIPTION OF THE REFERENCE CHARACTERS

1 . . . lamination film
2 . . . base material film
2a . . . upper surface
3 . . . resin film
3A . . . cured body layer
3a . . . upper surface
3b . . . hole
11 . . . multilayer printed wiring board
12 . . . substrate
12a . . . upper surface
13 . . . metal layer

1. A laminated body comprising a substrate and a cured body layer laminated on the substrate;
the cured body layer being formed by laminating a resin film on the substrate, preliminary-curing the resin film at 100° C. to 200° C. to form a preliminary-cured body layer, and performing a roughening treatment on the surface of the preliminary-cured body layer at 55° C. to 80° C.;
the resin film including an epoxy resin, a curing agent, a curing accelerator, and a surface treated substance obtained by performing a surface treatment, using 0.5 to 3.5 parts by weight of a silane coupling agent, on 100 parts by weight of an inorganic filler with a mean particle diameter of 0.05 to 1.5 μm, the resin film being formed from a resin composition in which a contained amount of the surface treated substance is within a range from 10 wt % to 80 wt % in a total 100 wt % of the epoxy resin, the curing agent, the curing accelerator, and the surface treated substance;
the silane coupling agent including a functional group reactable with the epoxy resin or the curing agent, wherein the functional group is an epoxy group, an imidazole group, or an amino group.

2. The laminated body according to claim 1, wherein the curing agent is at least one type selected from the group consisting of phenolic compounds having a biphenyl structure, phenolic compounds having a naphthalene structure, phenolic compounds having a dicyclopentadiene structure, phenolic compounds having an aminotriazine structure, active ester compounds, and cyanate ester resins.

3. The laminated body according to claim 1, wherein an imidazole silane compound is included in the resin composition within a range from 0.01 to 3 parts by weight with regard to a total 100 parts by weight of the epoxy resin and the curing agent.

4. The laminated body according to claim 1, wherein the surface of the cured body layer, on which a roughening treatment is performed, has an arithmetic mean roughness Ra equal to or less than 300 nm and a ten-point mean roughness Rz equal to or less than 3 μm.

5. The laminated body according to claim 1, wherein a swelling treatment is performed on the preliminary-cured body layer at 50° C. to 80° C., after the preliminary-curing but before the roughening treatment.

6. A method for producing a laminated body including a substrate and a cured body layer laminated on the substrate, the method comprising:
a step of laminating a resin film on the substrate to form the cured body layer;
a step of preliminary-curing the resin film laminated on the substrate at 100° C. to 200° C. to form a preliminary-cured body layer; and
a step of performing a roughening treatment on the surface of the preliminary-cured body layer at 55° C. to 80° C. to form a roughening-treated cured body layer, wherein the resin film includes an epoxy resin, a curing agent, a curing accelerator, and a surface treated substance obtained by performing a surface treatment, using 0.5 to 3.5 parts by weight of a silane coupling agent, on 100 parts by weight of an inorganic filler with a mean particle diameter of 0.05 to 1.5 μm, and the resin film is formed using a resin composition in which a contained amount of the surface treated substance is within a range from 10 wt % to 80 wt % in a total 100 wt % of the epoxy resin, the curing agent, the curing accelerator, and the surface treated substance, and
the silane coupling agent is a silane coupling agent that includes a functional group reactable with the epoxy resin or the curing agent, and the functional group is an epoxy group, an imidazole group, or an amino group.

7. The method for producing the laminated body, according to claim 6, wherein the curing agent used therein is at least one type selected from the group consisting of phenolic compounds having a biphenyl structure, phenolic compounds having a naphthalene structure, phenolic compounds having a dicyclopentadiene structure, phenolic compounds having an aminotriazine structure, active ester compounds, and cyanate ester resins.

8. The method for producing the laminated body, according to claim 6, wherein the resin composition used therein is a resin composition including an imidazole silane compound within a range from 0.01 to 3 parts by weight with regard to a total 100 parts by weight of the epoxy resin and the curing agent.

9. The method for producing the laminated body, according to claim 6, wherein the amount of time for a roughening treatment at the step of performing a roughening treatment is 5 to 30 minutes.

10. The method for producing the laminated body, according to claim 6, further comprising a step of performing a swelling treatment on the surface of the preliminary-cured body layer at 50° C. to 80° C.,
after the step of preliminary-curing but before the step of performing a roughening treatment.

11. The method for producing the laminated body, according to claim 10, wherein the amount of time for a swelling treatment at the step of performing a swelling treatment is 5 to 30 minutes.

12. The method for producing the laminated body, according to claim 6, wherein at the step of laminating, a lamination temperature is 70° C. to 130° C., and a lamination pressure is 0.1 to 2.0 MPa.
